(19) United States
(12) Patent Application Publication
(10) Pub. No.: US 2024/0101845 A1
(43) Pub. Date: Mar. 28, 2024

(54) COATED BODY

(71) Applicant: DAI NIPPON TORYO CO., LTD., Osaka (JP)

(72) Inventors: Shunsuke TAKAOKA, Tochigi (JP); Hiroki KAWASAKI, Aichi (JP); Akira SUETSUGU, Tochigi (JP); Yasuhiro ANZAI, Tochigi (JP); Kazuo MINAMI, Tochigi (JP)

(73) Assignee: DAI NIPPON TORYO CO., LTD., Osaka (JP)

(21) Appl. No.: 18/239,943

(22) Filed: Aug. 30, 2023

(30) Foreign Application Priority Data
Sep. 8, 2022 (JP) 2022-142861
Sep. 9, 2022 (JP) 2022-143940

(51) Int. Cl. C09D 11/40; C09D 11/322; C09D 11/38

(52) U.S. Cl. CPC C09D 11/40; C09D 11/322; C09D 11/38

(57) ABSTRACT

The present invention relates to a coated body comprising a decorative layer having excellent visibility and gradation characteristics and a wide color reproduction region, and more particularly, to a coated body comprising a substrate and a decorative layer, in which the decorative layer is formed from an ink set comprising at least a cyan ink, a magenta ink, and a yellow ink, and all of Ch, Mh, and Yh are 10% or more, in which Ch, Mh, and Yh are contrast ratios (%) of dried films having a thickness of 10 μm formed from the cyan ink, the magenta ink, and the yellow ink, respectively, and all of the following Relational Expressions (1) to (3) are satisfied:

0≤|Ch−Mh|≤25%; Expression (1)

0≤|Mh−Yh|≤25%; and Expression (2)

0≤|Yh−Ch|≤25%. Expression (3)

### BACKGROUND OF THE INVENTION

### 1. Technical Field

The present invention relates to a coated body, and particularly, to a coated body comprising a decorative layer having excellent visibility and gradation characteristics and a wide color reproduction region.

### 2. Description of the Related Art

A scope of application of inkjet printing is not limited to a printing paper and a film, and there are increasing demands for various media and applications such as decorating three-dimensional objects and durability that can withstand long-term outdoor use. In order to enhance design properties of a printed material, various methods for expanding a color reproduction region (gamut) have been proposed.

JP 2011-116876 A discloses an invention related to an ink set comprising a cyan ink, a magenta ink, a yellow ink, a light magenta ink, a light cyan ink, an orange ink, and a green ink. JP 2011-116876 A discloses that an ink set having an extended color reproduction region (gamut), in particular, an ink set having an extended color reproduction region in a blue region of a dark portion and excellent color reproducibility in other color regions can be provided by limiting a pigment used for each ink to a specific pigment type. In addition, the ink set described in JP 2011-116876 A is an ink set having excellent graininess in a high brightness region where graininess is easily noticeable.

JP 2014-159525 A discloses an invention related to an active energy ray curable inkjet recording ink set comprising at least a magenta ink, a cyan ink, and a yellow ink. JP 2014-159525 A discloses that it is possible to provide an active energy ray curable inkjet recording ink set having excellent color developability for a multi-color, in particular, color developability for a multi-color of orange, green, and violet by setting a ratio of a median diameter of a pigment used in each ink within a specific range.

JP 2015-218218 A discloses an invention related to an ink set for a building material comprising a cyan ink, a magenta ink, a yellow ink, and a green ink. JP 2015-218218 A discloses that since an ink for a building material is mainly used outdoors, there is a problem that color fading and discoloration occur due to wind and rain and sunlight and color reproducibility immediately after production cannot be maintained, and improvement of weather resistance is required, and therefore, weather resistance is improved by using Pigment Red 101 as a magenta inorganic pigment and color reproducibility is improved by compensating for a narrow color gamut by Pigment Red 101 using a green ink.

JP 2021-6615 A discloses an invention related to an ink set for single-pass printing comprising at least a cyan ink, a magenta ink, a yellow ink, and a gray ink. JP 2021-6615 A discloses that, in a case of reproducing a gray color, it is preferable to perform reproduction using three colors of CMY or four colors of CMYK rather than using only K from the viewpoint of graininess, but when reproduction is performed using three colors of CMY, there is a problem that metamerism occurs, metamerism is improved by using a gray ink as compared with the case of reproducing a gray color with a cyan ink, a magenta ink, and a yellow ink, and graininess is improved as compared with the case of reproducing a gray color with only black.

WO 2002/100959 A discloses an invention related to an ink set comprising one or two specific color inks in which a hue angle ∠H° defined in a CIELAB color space on a recording medium is within a specific range, in addition to three color inks of yellow, magenta, and cyan in which a hue angle ∠H° defined in the CIELAB color space on the recording medium is in a specific range. WO 2002/100959 A discloses that there is a problem that color development of a secondary color is significantly deteriorated in YMC three color inks in which a pigment solid content in the inks is reduced in order to improve graininess and gloss, but it is possible to widen a reproduction range of chroma without occurrence of deterioration of graininess and gloss using such specific color inks.

In addition, among the applications of inkjet printing, examples of applications for long-term outdoor use include applications for a building material such as ceramic siding, metal siding, and ceramic tiles.

JP 2013-49813 A discloses an invention related to a method of producing a decorative building material, the method comprising forming an ink layer using an inkjet ink containing a specific black pigment. JP 2013-49813 A discloses that it is possible to provide a decorative building material having excellent durability while suppressing a temperature rise of a building material even in a case of being subjected to insolation by using a specific black pigment.

### SUMMARY OF THE INVENTION

As described in JP 2011-116876 A, JP 2015-218218 A, JP 2021-6615 A, and WO 2002/100959 A, although the color reproduction region can be expanded by increasing the number of colors of the inks constituting the ink set, there are large disadvantages in both the initial cost and the running cost, such as an increase in initial introduction cost of a recording apparatus, an increase in cost of a consumable member such as a print head, and a significant increase in amount of ink required to obtain an image having the same density as that in the case of the CMY three color inks when a light color ink is used in combination.

In addition, as described in JP 2011-116876 A, JP 2014-159525 A, JP 2015-218218 A, WO 2002/100959 A, and JP 2013-49813 A, in a method of individually selecting the type and particle diameter of the pigment, and hue angle, a printed material having excellent gradation characteristics may not necessarily be obtained when performing color mixing of the inks. In particular, JP 2013-49813 A discloses an ink set using an organic pigment having excellent color developability and an inorganic pigment having poor color developability, but it is difficult to obtain a printed material having excellent color reproducibility and gradation characteristics using such an ink set.

Furthermore, since a conventional chromatic color ink has low hiding power and a property of transmitting light, in a case where visibility of an image is required when printing is performed on a transparent substrate or a colored substrate other than white, it is required to provide a hiding layer by a white ink or another base coat layer as a base to supplement the visibility.

Therefore, a method capable of obtaining a wide color reproduction region with a smaller number of colors of ink and coping with a wide range of media is desired.

An object of the present invention is to provide a coated body comprising a decorative layer having excellent visibility and gradation characteristics and a wide color reproduction region.

As a result of conducting intensive studies to achieve the above object, the present inventors found that a contrast ratio of each of cyan, magenta, and yellow three inks is increased and a difference in contrast ratio between the inks is suppressed to be in a specific range, such that a printed material having excellent visibility even for a transparent substrate or a colored substrate other than white can be provided, and a printed material having excellent color reproducibility can also be provided by improving color developability of each color alone and gradation characteristics at the time of color mixing, thereby accomplishing the present invention.

A coated body of the present invention is a coated body comprising a substrate and a decorative layer,
in which the decorative layer is formed from an ink set comprising at least a cyan ink, a magenta ink, and a yellow ink, and
all of Ch, Mh, and Yh are 10% or more, in which Ch, Mh, and Yh are contrast ratios (%) of dried films having a thickness of 10 μm formed from the cyan ink, the magenta ink, and the yellow ink, respectively, and all of the following Relational Expressions (1) to (3) are satisfied:

0≤|Ch−Mh|≤25%; Expression (1)

0≤|Mh−Yh|≤25%; and Expression (2)

0≤|Yh−Ch|≤25%. Expression (3)

In a preferred embodiment of the coated body of the present invention, a surface on which the decorative layer is printed has an L* value of 40.0 to 98.0 in a CIE(1976)L*a*b* color space.

In another preferred embodiment of the coated body of the present invention, the cyan ink contains a white pigment.

In still another preferred embodiment of the coated body of the present invention, the yellow ink contains a white pigment.

In still another preferred embodiment of the coated body of the present invention, a hue angle ∠H° of a dried film having a thickness of 10 μm formed from the cyan ink is in a range of 230° to 270°, a hue angle ∠H° of a dried film having a thickness of 10 μm formed from the magenta ink is in a range of 26° to 42°, a hue angle ∠H° of a dried film having a thickness of 10 μm formed from the yellow ink is in a range of 75° to 110°, wherein the hue angle ∠H° of a dried film having a thickness of 10 μm formed from the cyan ink, the hue angle ∠H° of a dried film having a thickness of 10 μm formed from the magenta ink, and the hue angle ∠H° of a dried film having a thickness of 10 μm formed from the yellow ink are values measured on a white substrate.

In still another preferred embodiment of the coated body of the present invention, a hue angle ∠H° of a dried film having a thickness of 10 μm formed by color mixing of the cyan ink and the magenta ink at a volume ratio of 1:1 is in a range of −20° to 25°, a hue angle ∠H° of a dried film having a thickness of 10 μm formed by color mixing of the magenta ink and the yellow ink at a volume ratio of 1:1 is in a range of 43° to 74°, a hue angle ∠H° of a dried film having a thickness of 10 μm formed by color mixing of the yellow ink and the cyan ink at a volume ratio of 1:1 is in a range of 111° to 160°, wherein the hue angle ∠H° of a dried film having a thickness of 10 μm formed by color mixing of the cyan ink and the magenta ink at a volume ratio of 1:1, the hue angle ∠H° of a dried film having a thickness of 10 μm formed by color mixing of the magenta ink and the yellow ink at a volume ratio of 1:1, and the hue angle ∠H° of a dried film having a thickness of 10 μm formed by color mixing of the yellow ink and the cyan ink at a volume ratio of 1:1 are values measured on a white substrate.

In still another preferred embodiment of the coated body of the present invention, all of Ch, Mh, and Yh are within a range of 55±25%.

In still another preferred embodiment of the coated body of the present invention, at least one of the inks constituting the ink set is an active energy ray curable ink containing a polymerizable compound containing an alkylene oxide as a structural unit.

In still another preferred embodiment of the coated body of the present invention, the magenta ink contains an iron oxide pigment, and a content of magnetite in the iron oxide pigment is 5 mass % or less.

In still another preferred embodiment of the coated body of the present invention, the iron oxide pigment is Pigment Red 101.

In still another preferred embodiment of the coated body of the present invention, the decorative layer is formed from a plurality of dot-shaped inks, and an average dot diameter of the inks is within a range of 70 μm to 250 μm.

In still another preferred embodiment of the coated body of the present invention, the coated body further comprises an ink receiving layer, in which a surface on which the decorative layer is printed is a surface of the ink receiving layer.

In still another preferred embodiment of the coated body of the present invention, the ink receiving layer contains a crosslinked resin.

According to the present invention, it is possible to provide a coated body comprising a decorative layer having excellent visibility and gradation characteristics and a wide color reproduction region.

### BRIEF DESCRIPTION OF THE DRAWINGS

FIG. 1 illustrates a calibration curve for determining a content of magnetite prepared in Examples.

### DETAILED DESCRIPTION

Hereinafter, the present invention will be described in detail.

The present invention relates to a coated body comprising a substrate and a decorative layer. In the present specification, the coated body is also referred to as a “coated body of the present invention”.

In the present specification, the coated body means a substrate on which a decorative layer is coated (specifically, a decorative layer is printed) on at least a part of the surface. In the present invention, the decorative layer may be formed directly on the substrate, or an additional layer such as an ink receiving layer may be present between the decorative layer and the substrate, and the decorative layer may be formed on the substrate with the additional layer interposed therebetween.

In the present specification, the decorative layer means a layer intended to impart a design to the substrate or impart a texture different from that of the substrate. Here, the design is a shape, a pattern, a color, or a combination thereof.

In the present specification, the substrate means an object on which the decorative layer is coated (specifically, the decorative layer is printed).

In the present specification, the ink receiving layer means a layer for facilitating fixing of ink. For example, when a high definition image is printed on the substrate, it is preferable to form an ink receiving layer on the substrate and perform printing on the ink receiving layer.

In the coated body of the present invention, a surface on which the decorative layer is printed has an L* value of preferably 40.0 to 98.0 and more preferably 50.0 to 98.0 in a CIE(1976)L*a*b* color space. L* represents color brightness, L*=0 represents black, and L*=100 represents white. When the L* value of the surface on which the decorative layer is printed is within the specified range, the color developability of the decorative layer can be improved, and excellent color reproducibility can be exhibited by combination with addition of a white pigment to a cyan ink described below. It is preferable that an a* value is −10.0 to 30.0 and a b* value is −25.0 to 40.0.

In the present specification, the L* value is a correlation amount of brightness calculated by Expression (1) of 4.1 base coordinate of JIS Z 8781-4:2013, and can be measured by a method or an apparatus usually used in the art, for example, can be measured using a spectrophotometer (for example, eXact, manufactured by X-Rite, Inc.).

In the coated body of the present invention, when the decorative layer is directly printed on the substrate, the “surface on which the decorative layer is printed” refers to a surface of the substrate. On the other hand, in a case where an additional layer such as an ink receiving layer exists between the decorative layer and the substrate, and the decorative layer is printed on the substrate with the additional layer interposed therebetween (in other words, in a case where the decorative layer is printed on the additional layer positioned on the substrate), the “surface on which the decorative layer is printed” refers to a surface of the additional layer (for example, the ink receiving layer).

In a case where the surface on which the decorative layer is printed is a surface of the additional layer (for example, the ink receiving layer), the L* value of the surface on which the decorative layer is printed is determined by measuring an L* value of the additional layer (for example, the ink receiving layer) while the additional layer (for example, the ink receiving layer) adheres to the substrate without being peeled off from the substrate.

In a case where an L* value of the surface of the substrate is out of a range of 40.0 to 98.0, the L* value of the surface on which the decorative layer is printed can be adjusted by forming an additional layer on the surface of the substrate. Examples of a method of adjusting the L* value of the additional layer to the specified range include selection of a pigment type, adjustment of an average dispersed-particle diameter of a pigment, adjustment of a pigment concentration, and use of a white pigment.

In the coated body of the present invention, the decorative layer is formed from an ink set comprising a cyan ink, a yellow ink, and a magenta ink. In the present specification, the ink set for forming the decorative layer is also referred to as an “ink set of the present invention”.

The ink set of the present invention is an ink set comprising at least CMY three color inks of a cyan ink (C), a magenta ink (M), and a yellow ink (Y), but is not limited thereto, and may comprise other inks such as a black ink (K), a special color ink such as an orange ink, a green ink, a violet ink, a light cyan ink, or a light magenta ink, a bright color ink such as metallic or pearl, and a clear ink not intended for coloring.

In the ink set of the present invention, all of Ch, Mh, and Yh are 10% or more, in which Ch, Mh, and Yh are contrast ratios (%) of dried films having a thickness of 10 μm formed from the cyan ink, the magenta ink, and the yellow ink, respectively, and all of the following Relational Expressions (1) to (3) are satisfied:

0≤|Ch−Mh|≤25%; Expression (1)

0≤|Mh−Yh|≤25%; and Expression (2)

0≤|Yh−Ch|≤25%. Expression (3)

According to the ink set of the present invention, it is possible to provide a printed material having excellent visibility even for a transparent substrate or a colored substrate other than white by increasing a contrast ratio of each of the CMY three color inks and suppressing a difference in the contrast ratio between the inks to a specific range while using a small number of colors of ink such as three colors of cyan, magenta, and yellow, and it is also possible to provide a printed material having excellent color reproducibility by improving the color developability of each color alone and the gradation characteristics at the time of color mixing. As a result, various designs can be applied to various substrates with vivid color tones.

In the ink set of the present invention, all of Ch, Mh, and Yh are 10% or more and preferably 20% or more. The color developability can be improved by increasing the contrast ratio. On the other hand, when the contrast ratio is less than 10%, the color reproduction region at the time of color mixing becomes small. In addition, when the contrast ratio is too high, chroma is reduced and the color becomes dull. In addition, when the inks are ejected from an inkjet printer to express a mixed color, in a case where a second ink droplet overlaps a first ink droplet, when the first ink droplet is hidden by the second ink droplet to such an extent that the coloring of the first ink droplet is affected, color reproducibility of the mixed color is not excellent. Therefore, all of Ch, Mh, and Yh are preferably within a range of 55±25% (30% to 80%), more preferably within a range of 55±20% (35% to 75%), and still more preferably within a range of 55±15% (40% to 70%).

In the ink set of the present invention, Ch, Mh, and Yh satisfy all of Relational Expressions (1) to (3). When there is a combination of CMY three color inks with a difference of 26% or more in contrast ratios, expression of the mixed color becomes difficult, and thus, the color reproduction region becomes small.

In the ink set of the present invention, Ch, Mh, and Yh preferably satisfy all of Relational Expressions (4) to (6):

0≤|Ch−Mh|≤23%; Expression (4)

0≤|Mh−Yh|≤23%; and Expression (5)

0≤|Yh−Ch|≤23%. Expression (6)

In the present specification, the contrast ratio of the dried film is measured according to Method B (hiding power test paper) of JIS K-5600-4-1:1999. Specific measurement examples will be described below.

After a single color solid image is printed on a white background portion and a black background portion of a hiding power test paper using an inkjet printer, L* values of the respective solid images are measured by a spectrophotometer, and a ratio of the both values is obtained.

Example: When the L* value in the ink dried film of the white background printed portion is Lw and the L* value in the ink dried film of the black background printed portion is Lb, the contrast ratio of the dried film can be determined by the following Expression (7).

Contrast ratio (%)=100×Lb/Lw Expression (7)

Note that a thickness of the ink dried film at the time of measuring the contrast ratio is 10 μm.

In the present specification, the ink dried film is prepared by the following method.

(Example) Each of CMY single color solid images (resolution of 360×360 dpi) is printed on a white background portion and a black background portion on a hiding power test paper using an inkjet printer (for example, an inkjet printer equipped with KM1024-LHB head (droplet 42 pl, manufactured by Konica Minolta, Inc.)). Thereafter, the ink is cured using a metal halide lamp to obtain an ink dried film. A thickness of the ink dried film is measured with a micrometer (for example, MDC-25MJ, manufactured by Mitutoyo Corporation).

Examples of a method of adjusting the contrast ratio of each of the cyan ink, the magenta ink, and the yellow ink include selection of a pigment type and selection of a pigment particle diameter. The pigments contained in the respective inks may be used alone or in combination of two or more thereof. In addition, as a method of increasing the contrast ratio, it is also effective to use a white pigment for each of the cyan ink, the magenta ink, and the yellow ink. In particular, the cyan ink or the yellow ink is often difficult to secure the contrast ratio, and therefore, it is preferable to use a white pigment.

The pigment used in the present invention is not particularly limited as long as it is a pigment usually used in inkjet inks, and a known pigment can be used.

Examples of the pigment used in the cyan ink include C.I. Pigment Blue 1, 15, 15:1, 15:2, 15:3, 15:4, 15:5, 15:6, 16, 17:1, 24, 24:1, 25, 26, 27, 28, 29, 36, 56, 60, 61, 62, 63, 75, 79, and 80.

Among them, C.I. Pigment Blue 15:3, 15:4, 28, and the like are preferable from the viewpoint of having high colorability or weather resistance and increasing the contrast ratio.

Examples of the pigment used in the magenta ink include C.I. Pigment Red 1, 2, 3, 4, 5, 6, 7, 8, 9, 10, 11, 12, 14, 15, 16, 17, 18, 19, 21, 22, 23, 31, 32, 38, 41, 48, 48:1, 48:2, 48:3, 48:4, 48:5, 49, 52, 52:1, 52:2, 53:1, 54, 57:1, 58, 60:1, 63, 64:1, 68, 81:1, 83, 88, 89, 95, 101, 104, 105, 108, 112, 114, 119, 122, 123, 136, 144, 146, 147, 149, 150, 164, 166, 168, 169, 170, 171, 172, 175, 176, 177, 178, 179, 180, 181, 182, 183, 184, 185, 187, 188, 190, 193, 194, 200, 202, 206, 207, 208, 209, 210, 211, 213, 214, 216, 220, 220, 221, 224, 226, 237, 238, 239, 242, 245, 247, 248, 251, 253, 254, 255, 256, 257, 258, 260, 262, 263, 264, 266, 268, 269, 270, 271, 272, 279, and 282.

Among them, C.I. Pigment Red 101 and the like are preferable from the viewpoint of having high colorability or weather resistance and increasing the contrast ratio.

Examples of the pigment used in the yellow ink include C.I. Pigment Yellow 1, 2, 3, 4, 5, 6, 7, 9, 10, 12, 13, 14, 15, 16, 17, 24, 32, 34, 35, 36, 37, 41, 42, 43, 49, 53, 55, 60, 61, 62, 63, 65, 73, 74, 75, 77, 81, 83, 87, 93, 94, 95, 97, 98, 99, 100, 101, 104, 105, 106, 108, 109, 110, 111, 113, 114, 116, 117, 119, 120, 123, 124, 126, 127, 128, 129, 130, 133, 138, 139, 150, 151, 152, 153, 154, 155, 165, 167, 168, 169, 170, 172, 173, 174, 175, 176, 179, 180, 181, 182, 183, 184, 185, 191, 193, 194, 199, 205, 206, 209, 212, 213, 214, 215, and 219.

Among them, C.I. Pigment Yellow 42, 120, 138, 150, 151, 155, 184, 213, and the like are preferable from the viewpoint of having high colorability or weather resistance and increasing the contrast ratio.

In the ink set of the present invention, the pigment is not limited to the preferred pigments described above, and other pigments can be used for the cyan ink, the magenta ink, and the yellow ink.

For the cyan ink, the magenta ink, and the yellow ink, both an organic pigment and an inorganic pigment can be used, and an inorganic pigment is preferably used in terms of excellent weather resistance.

The amount of the pigment in each of the cyan ink, the magenta ink, and the yellow ink is, for example, 5 to 25 mass % and preferably 6 to 20 mass %. When the amount of the pigment is small, even a pigment having excellent hiding power cannot exhibit sufficient hiding power, and color reproducibility may be difficult. In addition, when the amount of the pigment is large, the hiding power becomes too high, and color reproducibility of the mixed color may be difficult.

In the ink set of the present invention, one or more of the cyan ink, the magenta ink, and the yellow ink preferably contain a white pigment. The white pigment is preferable from the viewpoint of increasing the contrast ratio. In addition, in a case where the cyan ink, the magenta ink, and the yellow ink contain an inorganic pigment, in particular, in a case where the cyan ink and the yellow ink contain an inorganic pigment, a white pigment is preferably used in combination.

In particular, in the coated body of the present invention, the cyan ink used for forming the decorative layer preferably contains a white pigment. In CMY three colors of cyan (C), magenta (M), and yellow (Y), the visibility of the cyan ink is low, which may cause a decrease in the gradation characteristics at the time of color mixing. However, the visibility of the cyan ink can be enhanced by adding a white pigment to the cyan ink, such that the gradation characteristics at the time of color mixing of inks can be improved. Note that the visibility of the yellow ink may be low depending on the pigment type, and in such a case, it is preferable to add a white pigment to the yellow ink. Therefore, in an embodiment of the coated body of the present invention, the cyan ink and the yellow ink contain a white pigment. In addition, since the color developability can be improved by adding a white pigment to the ink, it is preferable to add a white pigment to the yellow ink and/or the magenta ink in addition to the cyan ink in order to increase the color developability. Therefore, in another embodiment of the coated body of the present invention, the cyan ink, the yellow ink, and the magenta ink contain a white pigment.

In the present specification, the visibility means a degree at which the decorative layer can be recognized without being affected by a ground such as a substrate, and in general, when the degree at which the decorative layer hides a ground such as a substrate (hiding power) increases, the visibility also increases.

Examples of the white pigment include inorganic pigments such as titanium oxide and zinc sulfide. The amount of the white pigment in the ink is, for example, 1 to 25 mass %, preferably 3 to 20 mass %, and more preferably 5 to 15 mass %, with respect to the total amount of the pigment contained in the ink. When a ratio of the white pigment with respect to the total pigment is too high, the color of the ink may be adversely affected. The white pigments may be used alone or in combination of two or more thereof.

Examples of the white pigment include C.I. Pigment White 1, 2, 4, 5, 6, 7, 11, 12, 18, 19, 21, 22, 23, 26, 27, and 28, and hollow particles.

Among them, C.I. Pigment White 6 and the like are preferable from the viewpoint of increasing the contrast ratio.

An average dispersed-particle diameter D50 of the pigments used in the cyan ink, the magenta ink, and the yellow ink is preferably within a range of 20 to 500 nm, more preferably within a range of 30 to 450 nm, and still more preferably within a range of 40 to 400 nm.

An average dispersed-particle diameter D50 of the white pigments in each ink of the cyan ink, the magenta ink, and the yellow ink is preferably within a range of 50 to 400 nm, more preferably within a range of 80 to 350 nm, and still more preferably within a range of 100 to 300 nm.

In the present specification, the average dispersed-particle diameter D50 of the pigments refers to a 50% particle diameter (D₅₀) of a volume-based particle size distribution of the pigments dispersed in the ink, and can be determined from a particle size distribution measured using a particle size distribution measuring apparatus (for example, a laser diffraction/scattering type particle size distribution measuring apparatus). The particle diameter is represented as a spherical equivalent diameter by a laser diffraction/scattering method.

In the ink set of the present invention, the L* value of the cyan ink represented in the CIE(1976)L*a*b* color space is preferably within a range of 50 to 85, the L* value of the magenta ink is preferably within a range of 40 to 75, and the L* value of the yellow ink is preferably within a range of 50 to 90. L* represents color luminance (brightness), L*=0 represents black, and L*=100 represents white. The L* value is obtained, for example, on a white background portion of the hiding power test paper. When the L* value of each ink is within the specified range, a balance of light and dark between the respective colors is obtained, and expression of the mixed color of light to dark colors is excellent. Note that a* and b* represent chromaticity indicating hue and chroma. a* represents a position of a color between red and green, a negative value indicates green, and a positive value indicates red. b* represents a position of a color between yellow and blue, a negative value indicates blue, and a positive value indicates yellow.

As an example of values other than the L* value, an a* value and a b* value of the cyan ink are −1 to −23 and −48 to −18, respectively, an a* value and a b* value of the magenta ink are 25 to 65 and −13 to 58, respectively, an a* value and a b* value of the yellow ink are −20 to 8 and 38 to 88, respectively, and the a* value and the b* value are obtained, for example, on a white background portion of a hiding power test paper.

Examples of a method of adjusting L*a*b* of each of the cyan ink, the magenta ink, and the yellow ink include selection of a pigment type. In particular, examples of a method of adjusting the L* value of each of the cyan ink, the magenta ink, and the yellow ink to the specified range include adjustment of an average dispersed-particle diameter of a pigment, adjustment of a pigment concentration in the ink, and use of a white pigment, in addition to selection of a pigment type.

In the present specification, the L* value, the a* value, the b* value of the ink are color coordinates calculated by specific expressions in the CIE(1976)L*a*b* color space as defined in JIS Z 8781-4:2013, can be measured without being particularly limited by a method (or an apparatus) usually used in the art, and can be measured, for example, using a spectrophotometer (for example, SpectroEye, manufactured by X-Rite, Inc.). Specifically, the L* value is a correlation amount of brightness calculated by Expression (1) of 4.1 base coordinate of JIS Z 8781-4:2013, and the a* value and the b* value are color coordinates calculated by Expressions (2) and (3) of 4.1 base coordinate of JIS Z 8781-4:2013 in the CIE(1976)L*a*b* color space.

In the ink set of the present invention, a hue angle ∠H° of a dried film having a thickness of 10 μm formed from the cyan ink is preferably within a range of 230° to 270°, more preferably within a range of 235° to 270°, and still more preferably within a range of 235° to 265°. In addition, a hue angle ∠H° of a dried film having a thickness of 10 μm formed from the magenta ink is preferably within a range of 26° to 42°, more preferably within a range of 28° to 42°, and still more preferably within a range of 30° to 42°. A hue angle ∠H° of a dried film having a thickness of 10 μm formed from the yellow ink is preferably within a range of 75° to 110°, more preferably within a range of 78° to 110°, and still more preferably within a range of 78° to 108°. The hue angle ∠H° is, for example, a value measured on a white background portion of a hiding power test paper. By setting the hue angle ∠H° of each ink within the specified range, it is easy to improve color reproducibility of a single color and a mixed color.

Examples of a method of adjusting the hue angle of the dried film formed from each of the cyan ink, the magenta ink, and the yellow ink include selection of a pigment type, adjustment of a pigment particle diameter, and adjustment of a pigment concentration in the ink.

In the present specification, the hue angle ∠H° of the dried film formed from the ink is also referred to as a CIELAB 1976 ab hue angle h_{ab} (CIE 1976 a,b hue-angle), is a correlation amount of hue calculated by Expression (11) of 4.2 in the CIE(1976)L*a*b* color space as defined in JIS Z 8781-4:2013, and can be determined, for example, from the a* value and the b* value of the ink obtained as described above. In addition, the hue angle ∠H° of the dried film formed by color mixing can also be determined by the same method as described above.

In the ink set of the present invention, a hue angle ∠H° of a dried film having a thickness of 10 μm formed by color mixing of the cyan ink and the magenta ink at a volume ratio of 1:1 is preferably within a range of −20° to 25°, more preferably within a range of −15° to 25°, and still more preferably within a range of −10° to 25°. In addition, a hue angle ∠H° of a dried film having a thickness of 10 μm formed by color mixing of the magenta ink and the yellow ink at a volume ratio of 1:1 is preferably within a range of 43° to 74°, more preferably within a range of 43° to 70°, and still more preferably within a range of 43° to 68°. A hue angle ∠H° of a dried film having a thickness of 10 μm formed by color mixing of the yellow ink and the cyan ink at a volume ratio of 1:1 is preferably within a range of 111° to 160°, more preferably within a range of 111° to 159°, and still more preferably within a range of 111° to 158°. The hue angle ∠H° is, for example, a value measured on a white background portion of a hiding power test paper. When the hue angle ∠H° of the dried film formed by color mixing is within the specified range, a printed material having excellent color reproducibility of the mixed color can be obtained.

Here, the color mixing means a method of performing printing by superimposing single color solid images. For example, the dried film formed by color mixing of a cyan ink and a magenta ink at a volume ratio of 1:1 refers to a dried film obtained by superimposing and printing a single color solid image printed using a cyan ink and a single color solid image printed using a magenta ink at a volume ratio of 1:1.

Examples of a method of adjusting the hue angles of the dried films formed by color mixing of the cyan ink and the magenta ink, the magenta ink and the yellow ink, and the yellow ink and the cyan ink include selection of a pigment type and adjustment of a pigment concentration in the ink.

In the ink set of the present invention, regarding color mixing of the cyan ink, the magenta ink, and the yellow ink, an L* value of the dried film formed by color mixing of the cyan ink, the magenta ink, and the yellow ink at a volume ratio of 1:1:1, which is represented in the CIE(1976)L*a*b* color space, is preferably within a range of 30 to 90, more preferably within a range of 35 to 85, and still more preferably within a range of 40 to 80. In addition, an L* value of the dried film formed by color mixing of the cyan ink and the magenta ink at a volume ratio of 1:1, which is represented in the CIE(1976)L*a*b* color space, is preferably within a range of 30 to 80, more preferably within a range of 30 to 75, and still more preferably within a range of 30 to 70. An L* value of the dried film formed by color mixing of the cyan ink and the yellow ink at a volume ratio of 1:1, which is represented in the CIE(1976)L*a*b* color space, is preferably within a range of 40 to 85, more preferably within a range of 40 to 80, and still more preferably within a range of 45 to 80. An L* value of the dried film formed by color mixing of the magenta ink and the yellow ink at a volume ratio of 1:1, which is represented in the CIE(1976)L*a*b* color space, is preferably within a range of 35 to 80, more preferably within a range of 35 to 75, and still more preferably within a range of 40 to 75. The L* value is, for example, a value measured on a white background portion of a hiding power test paper. When the L* value at the time of color mixing of the inks is within the specified range, a balance of light and dark between the respective colors is obtained, and expression of the mixed color of light to dark colors is excellent.

Here, the color mixing means a method of performing printing by superimposing single color solid images. For example, the dried film formed by color mixing of the cyan ink, the magenta ink, and the yellow ink at a volume ratio of 1:1:1 refers to a dried film obtained by superimposing and printing a single color solid image printed using a cyan ink, a single color solid image printed using a magenta ink, and a single color solid image printed using a yellow ink, at a volume ratio of 1:1:1.

As an example of values other than the L* value, an a* value and a b* value of the dried film formed by color mixing of the cyan ink, the magenta ink, and the yellow ink at a volume ratio of 1:1:1, which are represented in the CIE(1976)L*a*b* color space, are −1 to −23 and −48 to −18, respectively, an a* value and a b* value of the dried film formed by color mixing of the cyan ink and the magenta ink at a volume ratio of 1:1, which are represented in the CIE(1976)L*a*b* color space, are 25 to 65 and −13 to 58, respectively, an a* value and a b* value of the dried film formed by color mixing of the cyan ink and the yellow ink at a volume ratio of 1:1, which are represented in the CIE(1976)L*a*b* color space, are −20 to 8 and 38 to 88, respectively, and an a* value and a b* value of the dried film formed by color mixing of the magenta ink and the yellow ink at a volume ratio of 1:1, which are represented in the CIE(1976)L*a*b* color space, are −20 to 8 and 38 to 88, respectively. The a* value and the b* value are, for example, values measured on a white background portion of a hiding power test paper.

Examples of a method of adjusting L*a*b* of each of the dried film formed by color mixing of the cyan ink, the magenta ink, and the yellow ink at a volume ratio of 1:1:1, the dried film formed by color mixing of the cyan ink and the magenta ink at a volume ratio of 1:1, the dried film formed by color mixing of the cyan ink and the yellow ink at a volume ratio of 1:1, the dried film formed by color mixing of the magenta ink and the yellow ink at a volume ratio of 1:1 include selection of a pigment type. In particular, as the method of adjusting, to the specified range, the L* value of each of the dried film formed by color mixing of the cyan ink, the magenta ink, and the yellow ink at a volume ratio of 1:1:1, the dried film formed by color mixing of the cyan ink and the magenta ink at a volume ratio of 1:1, the dried film formed by color mixing of the cyan ink and the yellow ink at a volume ratio of 1:1, the dried film formed by color mixing of the magenta ink and the yellow ink at a volume ratio of 1:1, a white pigment is preferably used. In addition to the selection of the pigment type used in each ink, adjustment of an average dispersed-particle diameter of the pigment, adjustment of a pigment concentration in the ink, and the like can be used.

In the coated body of the present invention, at least one of the inks constituting the ink set used for formation of the decorative layer (that is, the ink set of the present invention) is preferably an active energy ray curable ink containing a polymerizable compound containing an alkylene oxide as a structural unit, and all the inks constituting the ink set used for formation of the decorative layer are more preferably active energy ray curable inks containing a polymerizable compound containing an alkylene oxide as a structural unit. Wettability of the ink to a surface to be printed can be improved by using the polymerizable compound containing an alkylene oxide as a structural unit, such that color developability of the decorative layer can be improved. As an example of the polymerizable compound containing an alkylene oxide as a structural unit, a polymerizable compound containing an ethylene oxide as a structural unit has an ether bond having a structure of —CH₂CH₂O—, and a polymerizable compound containing a propylene oxide as a structural unit has an ether bond having a structure of —CH₂CH(CH₃)O— or —CH₂CH₂CH₂O—. In addition, as the polymerizable compound containing an alkylene oxide as a structural unit, there is also a polymerizable compound containing plural kinds of alkylene oxides as structural units. The amount of the polymerizable compound containing an alkylene oxide as a structural unit in the ink is preferably 10 to 90 mass % and more preferably 20 to 85 mass %. The polymerizable compounds containing an alkylene oxide as a structural unit may be used alone or in combination of two or more thereof.

In the coated body of the present invention, the decorative layer is preferably formed from a plurality of dot-shaped inks. Therefore, the decorative layer can be thickened, and the color developability of the decorative layer can be further improved. The decorative layer formed from a plurality of dot-shaped inks can be formed by performing inkjet printing using an active energy ray curable ink, and curing ink droplets in a dot shape.

In addition, in the coated body of the present invention, in a case where the decorative layer is formed from a plurality of dot-shaped inks, an average dot diameter of the inks is preferably within a range of 70 μm to 250 μm, more preferably within a range of 80 μm to 220 μm, and still more preferably within a range of 90 μm to 190 μm.

One of the parameters that can control the average dot diameter is a standing time from when the ink is printed on a surface to be printed (in other words, from when the ink is landed on the surface to be printed) to when the curing of the ink is started (in other words, to the time point when the ink landed on the surface to be printed is irradiated with an active energy ray) (hereinafter, referred to as a “setting time”). A wet-spreading or permeation process of the ink changes depending on the setting time, and the average dot diameter tends to increase when the setting time is long.

Here, the average dot diameter refers to a diameter of a dot in a state where the ink is printed on the surface to be printed, diameters of arbitrary five dots are measured with a microscope for the ink of each color, and the average value of the diameters of all the measured dots is taken as the average dot diameter. In a case where the shape of the dot observed with the microscope is not a perfect circle but an ellipse or the like, the longest distance among the distances connecting two points on an outer periphery of the dot is taken as the diameter of the dot.

In the coated body of the present invention, a thickness of the decorative layer is, for example, 1 to 70 μm and preferably 2 to 60 μm from the viewpoint of improving color developability.

Next, a preferred embodiment of the ink that can be used in the ink set of the present invention (that is, the ink that can be used for forming the decorative layer) will be described. The content described herein applies to any of the cyan ink, the magenta ink, and the yellow ink described above, as well as other inks that may be used, unless otherwise stated (for example, unless the cyan ink or the like and the ink are specified). In the present specification, the ink used for forming the decorative layer is also referred to as an “ink for a decorative layer”.

The ink for a decorative layer is preferably an ink for printing by a droplet ejection type printing apparatus, and particularly preferably an inkjet ink, but is not limited thereto, and various printing methods such as a gravure printing method, an offset printing method, a flexographic printing method, a screen printing method, and a coater method can be performed.

The ink for a decorative layer is preferably an ink that can be cured by irradiation with an active energy ray such as an ultraviolet ray, a visible ray, or an electron beam. Such an ink is generally referred to as an “active energy ray curable ink”. In addition, an ink set comprising active energy ray curable inks may be referred to as an “active energy ray curable ink set”.

The ink for a decorative layer preferably contains a polymerizable compound and a photopolymerization initiator.

The polymerizable compound is a compound that causes a polymerization reaction via a functional group exhibiting radical polymerizability (for example, a photopolymerizable unsaturated group such as a carbon-carbon double bond constituting an acryloyl group, a methacryloyl group, a vinyl group, or an allyl group). A carbon-carbon double bond exhibiting radical polymerizability is also referred to as an “ethylenically unsaturated double bond”. The polymerizable compounds may be used alone or in combination of two or more thereof.

The polymerizable compound is classified as a monofunctional polymerizable compound or a polyfunctional polymerizable compound. Here, examples of the monofunctional polymerizable compound include a monofunctional polymerizable monomer having one radically polymerizable functional group (for example, a monofunctional polymerizable monomer having one polymerizable unsaturated group) and a monofunctional polymerizable oligomer having one radically polymerizable functional group (for example, a monofunctional polymerizable oligomer having one polymerizable unsaturated group). Examples of the polyfunctional polymerizable compound include a polyfunctional polymerizable monomer having two or more radically polymerizable functional groups (for example, a polyfunctional polymerizable monomer having two or more polymerizable unsaturated groups) and a polyfunctional polymerizable oligomer having two or more radically polymerizable functional groups (for example, a polyfunctional polymerizable oligomer having two or more polymerizable unsaturated groups).

It is preferable that 0.01≤B/A≤0.50 and 30 mass %≤A+B≤95 mass % in which A is the amount (mass %) of the monofunctional polymerizable compound contained in the ink for a decorative layer and B is the amount (mass %) of the polyfunctional polymerizable compound contained in the ink for a decorative layer. By setting a ratio of the polyfunctional polymerizable compound to the monofunctional polymerizable compound to 0.50 or less in the ink in which the total amount of the polymerizable compound is 30 to 95 mass %, curing shrinkage of the film can be suppressed, and adhesion of the film itself can be improved. This makes it possible to ensure adhesion to various substrates and coating films. Furthermore, curability and film strength can be secured by setting the amounts of the monofunctional polymerizable compound and the polyfunctional polymerizable compound contained in the ink to the specified ratios.

An average number of the functional groups of the polymerizable compound contained in the ink is preferably 1.25 or less and more preferably 1.01 to 1.25. In order to ensure the film strength by providing an appropriate crosslinked structure while reducing the number of reaction points in the entire system to suppress the curing shrinkage, as a result of examining the number of optimum reaction points and a crosslinking density, when the average number of functional groups of the polymerizable compound contained in the ink is 1.25 or less, particularly 1.01 to 1.25, the effect of suppressing the curing shrinkage of the film is high, the adhesion of the film itself can be greatly improved, and the film strength can be maintained. This makes it possible to ensure adhesion to various substrates and coating films and film strength.

In the present specification, the average number of functional groups of the polymerizable compound contained in the ink can be calculated as follows.

Average number of functional groups=[Total number of ethylenically unsaturated double bonds contained in polymerizable compound]/[Total number of molecules of polymerizable compound] Calculation Formula (1)

Here, the “total number of ethylenically unsaturated double bonds contained in polymerizable compound” in Calculation Formula (1) is calculated by multiplying the number of ethylenically unsaturated double bonds per molecule of the polymerizable compound by the total number of molecules of the polymerizable compound. In a case where a plurality of types of polymerizable compounds are blended in the ink, the number of ethylenically unsaturated double bonds is calculated for each type, and the total number of ethylenically unsaturated double bonds is referred to as the number of all ethylenically unsaturated double bonds.

(Example of Method of Determining Average Number of Functional Groups of Polymerizable Compound)

The total amount of the polymerizable compound is 100 parts by mass.

Polymerizable compound A: number of ethylenically unsaturated double bonds=1, molecular weight X_{A}, 30 parts by mass

Polymerizable compound B: number of ethylenically unsaturated double bonds=2, molecular weight X_{B}, 70 parts by mass

Average number of functional groups={(1×30/X_{A})+(2×70/X_{B})}/{(30/X_{A})+(70/X_{B})}

Since the average number of functional groups is 1.01 to 1.25, it is useful to use a polyfunctional polymerizable compound having a large ethylenically unsaturated double bond equivalent. The ethylenically unsaturated double bond equivalent is a value obtained by dividing a molecular weight by the number of ethylenically unsaturated double bonds contained in one molecule. In a case where the ethylenically unsaturated double bond is derived from a (meth)acryloyl group, it is also referred to as an “acryl equivalent”. In general, as the value increases, a distance between crosslinking points increases, and the crosslinking density decreases, and as a result, this can contribute to reduction of curing shrinkage.

The polymerizable compound contained in the ink preferably contains 40 to 90 mass % of the monofunctional polymerizable compound. When the amount of the monofunctional polymerizable compound with respect to the entire polymerizable compound is 40 mass % or more, adhesion and flexibility can be improved. In addition, when a ratio of the monofunctional polymerizable compound is too high, the film strength and curability are deteriorated, and thus, the ratio of the monofunctional polymerizable compound to the entire polymerizable compound is preferably 90 mass % or less.

The ink for a decorative layer preferably contains a polymerizable compound having a heterocyclic skeleton. By using a polymerizable compound having a heterocyclic skeleton, curability can be improved. In addition, the polymerizable compound having a heterocyclic skeleton is preferably a nitrogen-containing polymerizable compound, and more preferably a polymerizable compound having a heterocyclic skeleton containing a nitrogen atom. In particular, the nitrogen-containing polymerizable compound as a polymerizable compound having a heterocyclic skeleton has a high effect of reducing polymerization inhibition by oxygen during curing, and can improve the curability of the ink. The amount of the polymerizable compound having a heterocyclic skeleton in the ink is preferably 0.1 to 20 mass %.

The ink for a decorative layer preferably contains a polymerizable compound having a hydroxyl group. By using a polymerizable compound having a hydroxyl group, it is possible to improve adhesion to a substrate and film strength by hydrogen bonding or chemical bonding via a hydroxyl group. In addition, as with the polymerizable compound having a heterocyclic skeleton, there is an effect of reducing oxygen inhibition during curing, and improvement of curability can be expected. In addition, in an embodiment of the present invention, the ink contains at least one of a polymerizable compound having a hydroxyl group and a silane compound to be described below, and preferably contains both a polymerizable compound having a hydroxyl group and a silane compound. The amount of the polymerizable compound having a hydroxyl group in the ink is preferably 0.1 to 20 mass %.

The ink for a decorative layer preferably contains a polymerizable compound having a silicon atom, and more preferably contains a polymerizable compound represented by the following Structural Formula (1). Adhesion to the substrate can be improved by using a polymerizable compound having a silicon atom as a silane compound. In particular, the polymerizable compound represented by Structural Formula (1) has an excellent effect of improving the adhesion. The amount of the polymerizable compound having a silicon atom in the ink is preferably 0.1 to 20 mass %.

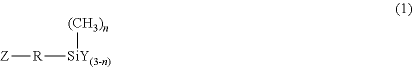

In Structural Formula (1), n is 1 to 3, Y is a methoxy group or an ethoxy group, R is an alkylene group selected from C3, and Z is a (meth)acryloxy group.

A monofunctional polymerizable monomer in which an alkyl chain or an alkylene glycol chain is extended is preferable because odor is reduced by an increase in molecular weight as compared with that before the chain is extended. The polymerizable compound containing an alkylene oxide as a structural unit is, for example, a monofunctional polymerizable monomer modified with an alkylene glycol such as polyoxyethylene mono(meth)acrylate, polyoxypropylene mono(meth)acrylate, polyoxybutylene mono(meth)acrylate, or ethoxydiethylene glycol acrylate.

Examples of the polymerizable compound containing an alkylene oxide as a structural unit also include diethylene glycol di(meth)acrylate, dipropylene glycol di(meth)acrylate, triethylene glycol di(meth)acrylate, tripropylene glycol di(meth)acrylate, tetraethylene glycol di(meth)acrylate, propylene oxide (PO)-modified neopentyl glycol di(meth)acrylate, polyethylene glycol di(meth)acrylate, polypropylene glycol di(meth)acrylate, and polytetramethylene glycol di(meth)acrylate.

The ink for a decorative layer preferably contains a silane coupling agent, and more preferably contains a silane coupling agent represented by the following Structural Formula (2). Adhesion to the substrate can be improved by using a silane coupling agent as a silane compound. In addition, a silane compound represented by the following Structural Formula (2) has more excellent pigment dispersibility, and the storage stability of the ink can be improved. The amount of the silane coupling agent in the ink is preferably 0.1 to 20 mass %. The silane coupling agents may be used alone or in combination of two or more thereof.

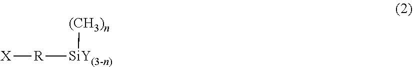

In Structural Formula (2), n is 1 to 3, Y is a methoxy group or an ethoxy group, R is an alkylene group selected from C3, and X is a glycidoxy group or an epoxycyclohexyl group.

Note that the epoxycyclohexyl group is a cyclohexyl group in which two carbon atoms constituting a cyclohexyl ring and an oxygen atom form an epoxy group, and is a group having a fused ring structure of an epoxy ring and a cyclohexyl ring.

The ink for a decorative layer may contain a coloring material such as a dye or a pigment, and in this case, the ink for a decorative layer preferably contains a pigment, particularly an inorganic pigment, from the viewpoint of weather resistance. A content of the coloring material is, for example, 1 to 20 mass %. The coloring materials may be used alone or in combination of two or more thereof. Here, for the cyan ink, the magenta ink, and the yellow ink, the pigment type is preferably selected from the viewpoint of adjusting the contrast ratio of the ink and the like. The pigments that can be used for the cyan ink, the magenta ink, and the yellow ink are as described above.

In addition, among the inks for a decorative layer, the magenta ink preferably contains an iron oxide pigment and has a content of magnetite of 5 mass % or less in the iron oxide pigment.

The iron oxide pigment is classified as an inorganic pigment, and is a pigment capable of imparting weather resistance to a printed material. As the iron oxide pigment, black iron oxide (iron black), yellow iron oxide (yellow iron), and red iron oxide are widely known. The red iron oxide is a red-brown pigment containing diiron trioxide (Fe₂O₃) as a main component, and the color tone ranges from yellow to purple depending on the size of the particles and the like. The magenta ink is preferably a magenta ink using the diiron trioxide as an iron oxide pigment.

Preferred examples of a magenta pigment (pigment exhibiting a magenta color) among the iron oxide pigments include red iron oxides such as Pigment Red 101 (C.I. Pigment Red 101) and Pigment Red 102 (C.I. Pigment Red 102). Pigment Red 102 is a pigment derived from a natural product, whereas Pigment Red 101 is a synthetic pigment, and thus Pigment Red 101 has a higher purity of diiron trioxide (Fe₂O₃), which is preferable.

The amount of the iron oxide pigment contained in the magenta ink is preferably in a range of 0.5 to 15 mass % and more preferably in a range of 1 to 10 mass %. The iron oxide pigments may be used alone or in combination of two or more thereof.

In the magenta ink containing an iron oxide pigment, a content of magnetite in the iron oxide pigment is preferably 5 mass % or less, more preferably 0.01 mass % or more and 5 mass % or less, still more preferably 0.01 mass % or more and 4 mass % or less, and particularly preferably 0.01 mass % or more and 3 mass % or less. The present inventors have found that when the amount of magnetite contained in the iron oxide pigment as an impurity exceeds 5 mass % in the iron oxide pigment, the storage stability of the ink is deteriorated, leading to ink ejection failure after storage for a certain period (for example, one week or longer). Since color separation may occur when the ink is stored for a certain period of time, the ink is often shaken well before use. However, it has been found that when the amount of magnetite contained in the iron oxide pigment as an impurity exceeds 5 mass % in the iron oxide pigment, magnetite precipitates after storage for a certain period of time, and ejection of the ink becomes unstable even when the ink is shaken well thereafter.

In addition, since magnetite has ferromagnetism, it is known that magnetite has high cohesiveness due to magnetic interaction between particles, and it is significantly difficult to control dispersion. In particular, since an inkjet head ejects an ink from a minute ejection nozzle, when the amount of magnetite contained in the iron oxide pigment as an impurity exceeds 5 mass % in the iron oxide pigment, magnetite is aggregated in the vicinity of the nozzle, and when the ink is ejected again after the printing is stopped, ejection failure may occur even in a short pause time. Furthermore, since magnetite is black, blackness may be mixed in a printed material, and color stability is impaired.

Magnetite is black iron oxide that is also naturally present as magnetite, and is also referred to as triiron tetraoxide (Fe₃O₄). This magnetite is an iron oxide that is also contained in a small amount in a magenta pigment derived from a natural product such as Pigment Red 102, and is an iron oxide that is usually contained in a small amount as an impurity even in a synthetic magenta pigment such as Pigment Red 101.

In the present specification, the content of magnetite in the iron oxide pigment can be estimated by measuring an X-ray diffraction pattern of the iron oxide pigment by an X-ray diffraction method, and then comparing a peak intensity value of the X-ray diffraction pattern with a calibration curve for determining a content of magnetite described below. In the present specification, the estimated value is referred to as a “content of magnetite in the iron oxide pigment”.

In order to create a calibration curve for determining the content of magnetite, first, a plurality of mixtures obtained by mixing magnetite with diiron trioxide are prepared. The amount of magnetite with respect to 100 mass % of the mixture is, for example, 10 mass %, 5 mass %, or 1 mass %, but is not limited thereto. Since magnetite is contained in the iron oxide pigment as an impurity, high-purity diiron trioxide used as a reagent for various types of analysis such as elemental analysis is used for creating a calibration curve. Note that such a high-purity reagent for analysis cannot be used as an ink pigment.

Next, the diffraction patterns of the plurality of prepared mixtures are obtained by measurement by an X-ray diffraction method. From each of the obtained diffraction patterns, a peak intensity value (A) of a first peak of diiron trioxide and a peak intensity value (B) of a position of a first peak of magnetite are read at a position of the first peak of diiron trioxide (33.15° 2θ, ICDD:01-085-0599) and a position of the first peak of magnetite (35.62° 2θ, ICDD:01-084-9337) to calculate a peak intensity ratio (B/A) of the two values, 10 points or more are plotted on a graph in which a vertical axis (y axis) is the peak intensity ratio (B/A) and a horizontal axis (x axis) is the amount (mass %) of magnetite with respect to 100 mass % of the mixture, and an approximate straight line by the least squares method is drawn using all the plotted points, such that a calibration curve can be created. The approximate straight line by the least squares method can be easily drawn, for example, by selecting a linear approximation of an approximate curve option from a format setting of the approximate curve of the graph in which the calibration curve is drawn on Microsoft Excel, which is spreadsheet software manufactured by Microsoft Corporation. The calibration curve is reliable when a correlation coefficient is 0.99 or more. The correlation coefficient can be easily obtained by selecting “display R-2-squared value in graph” from the format setting of the approximate curve of the graph on which the calibration curve is drawn on Excel. The position A of the first peak of diiron trioxide and the position B of the first peak of magnetite in the diffraction pattern are taken from International Centre for Diffraction Data (ICDD) of LightStone Corp. The first peak refers to a peak having the highest intensity observed in the diffraction pattern.

The obtained calibration curve is represented by the following Expression (1):

y=ax+b Expression (1)

(where a is the slope of the straight line and b is the intercept with the y-axis).

For example, an arbitrary iron oxide pigment is subjected to an X-ray diffraction method, peak intensity values A and B are read from the obtained X-ray diffraction pattern, and the content of magnetite in the iron oxide pigment can be determined from Expression (1).

The magnetite contained in the iron oxide pigment can be removed by using a magnetic body. For example, a dispersion of an iron oxide pigment is prepared using an appropriate solvent (methyl ethyl ketone or the like), and then the dispersion is passed through a wire mesh of a magnetic body, such that magnetite contained in the iron oxide pigment is captured by the magnetic body, and a content of magnetite in the iron oxide pigment can be reduced. In addition, it is also possible to significantly reduce the content of magnetite in the iron oxide pigment by repeatedly passing the dispersion through the wire mesh of the magnetic body. Examples of a preferred magnetic body include stainless steel having magnetism in which a neodymium magnet is adsorbed.

In addition, a content of magnetite in the magenta ink is preferably 1 ppm by mass or more and 10,000 ppm by mass or less, more preferably 1 ppm by mass or more and 7,500 ppm by mass or less, and still more preferably 1 ppm by mass or more and 5,000 ppm by mass or less, from the viewpoint of ejection stability after storage.

In the present specification, the content of magnetite in the magenta ink can be determined from the content of the iron oxide pigment in the magenta ink and the content of magnetite in the iron oxide pigment.

In addition, the present inventors have found that a phenomenon of unstable ejection due to the presence of magnetite becomes remarkable in the following (i) to (iii). Therefore, in order to further improve the ejection stability after storage of the magenta ink containing an iron oxide pigment, an ejection temperature of the ink, a storage temperature of the ink, a viscosity of the ink, and a particle diameter of the iron oxide pigment are examined.

(i) A difference between the ejection temperature of the ink and the storage temperature of the ink is large.

(ii) The viscosity of the ink is low.

(iii) The particle diameter of the iron oxide pigment is large.

(i) Ejection Temperature of Ink and Storage Temperature of Ink

In a case where the magenta ink containing an iron oxide pigment is stored, the storage temperature of the ink is preferably within a range of 0 to 35° C. In addition, in a case where printing is performed using the magenta ink containing an iron oxide pigment, the temperature of the ink when the ink is ejected from a printing apparatus (the ejection temperature of the ink) is preferably within a range of 20 to 55° C. Therefore, as for the magenta ink containing an iron oxide pigment, the temperature difference between the storage temperature of the ink and the ejection temperature of the ink is preferably 40° C. or lower and more preferably within a range of 0 to 35° C.

(ii) Viscosity of Ink

In the magenta ink containing an iron oxide pigment, a viscosity at the ejection temperature of the ink is preferably within a range of 5 to 20 mPa·s. Note that, as described above, the ejection temperature of the ink is preferably within a range of 20 to 55° C. The viscosity of the ink can be measured using a cone-plate viscometer.

(iii) Particle Diameter of Iron Oxide Pigment

In the magenta ink containing an iron oxide pigment, a dispersed-particle diameter D50 of the iron oxide pigment in the magenta ink is preferably within a range of 50 to 400 nm, more preferably within a range of 80 to 300 nm, and still more preferably within a range of 100 to 200 nm.

In addition, in the magenta ink containing an iron oxide pigment, a dispersed-particle diameter D100 of the iron oxide pigment in the magenta ink is preferably within a range of 100 to 600 nm, more preferably within a range of 150 to 500 nm, and still more preferably within a range of 200 to 400 nm.

In addition, in the magenta ink containing an iron oxide pigment, a dispersed-particle diameter D10 of the iron oxide pigment in the magenta ink is preferably within a range of 10 to 300 nm, more preferably within a range of 20 to 250 nm, and still more preferably within a range of 30 to 200 nm. By setting the dispersed-particle diameter D50 of the iron oxide pigment to 50 to 400 nm, in particular, and especially in consideration of the dispersed-particle diameter D100 and the dispersed-particle diameter D10, by setting the dispersed-particle diameter D50 of the iron oxide pigment to be within a range of 50 to 400 nm, the dispersed-particle diameter D100 of the iron oxide pigment to be within a range of 100 to 600 nm, and the dispersed-particle diameter D10 of the iron oxide pigment to be within a range of 10 to 300 nm, it is possible to improve hiding power as the magenta ink and the dispersion stability of the iron oxide pigment in the ink.

In the present specification, the dispersed-particle diameter D50 of the pigment refers to a 50% particle diameter (D₅₀) of a volume-based particle size distribution of the pigments dispersed in the ink, the dispersed-particle diameter D100 of the pigment refers to a 100% particle diameter (D₁₀₀) of a volume-based particle size distribution of the pigments dispersed in the ink, the dispersed-particle diameter D10 of the pigment refers to a 10% particle diameter (D₁₀) of a volume-based particle size distribution of the pigments dispersed in the ink, and these dispersed-particle diameters can be determined from a particle size distribution measured using a particle size distribution measuring apparatus (for example, a laser diffraction/scattering type particle size distribution measuring apparatus). The particle diameter is represented as a spherical equivalent diameter by a laser diffraction/scattering method.

The ink for a decorative layer may further contain a dispersant as necessary to disperse the pigments. A content of the dispersant in the ink is, for example, 0.1 to 5 mass %. The dispersants may be used alone or in combination of two or more thereof.

The dispersant preferably comprises a dispersant having a base value of 30 to 70 mgKOH/g and/or an acid value of 10 to 150 mgKOH/g. The dispersion stability of the pigment can be improved by using a dispersant having such a base value and/or acid value.

The ink for a decorative layer may contain a resin. The resin plays a role in forming a coating film on a substrate while capturing a solid component such as a pigment, and contributes to improvement of adhesion of the ink to the substrate.

Specific examples of the resin include polyvinyl acetate, a vinyl chloride-vinyl acetate copolymer, a vinyl chloride resin, chlorinated rubber, a chlorinated polyethylene resin, a chlorinated polypropylene resin, a chlorinated ethylene-vinyl acetate resin, an acrylic resin, a polystyrene resin, a polyamide resin, a polyurethane resin, a polyolefin resin, a silicone resin, a fluorine resin, an epoxy resin, a polyester resin, a ketone resin, a phenol resin, a polyvinyl alcohol, a polyvinyl alcohol derivative (an anion-modified polyvinyl alcohol or the like), cellulose, a cellulose derivative (hydroxymethyl cellulose, hydroxyethyl cellulose, cellulose acetate, or the like), a rosin-based resin, an alkyd resin, alginic acid, and an alginic acid derivative (propylene glycol alginate or the like). In addition, modified products of these resins are also included. For example, examples of a resin having a hydroxyl group include modifications such as hydroxyalkyl etherification modification and carboxylic acid modification.

The amount of the resin in the ink is preferably 25 mass % or less, particularly 10 mass % or less, and more preferably 8 mass % or less. When the amount of the resin is too large, curing failure may be caused. A lower limit of the content of the resin in the ink is, for example, 0.1 mass % or more and preferably 0.3 mass % or more. The resins may be used alone or in combination of two or more thereof.

The ink for a decorative layer may optionally contain, as other components, additives such as a surface conditioner, an ultraviolet absorber, a radical scavenger, an antioxidant, a plasticizer, a rust inhibitor, a solvent, an antibacterial agent, an antiviral agent, a viscosity modifier, a filler, an antifoaming agent, a charge control agent, a stress relaxation agent, a penetrant, a bright material, a light guide material, a magnetic material, and a phosphor.

The ink for a decorative layer can be prepared by mixing various components appropriately selected as necessary.

The printing using the ink set of the present invention is preferably performed particularly by an inkjet printing method. In inkjet printing, various inkjet printers can be used. Examples of the inkjet printer include an inkjet printer that ejects an ink by a charge control method or a piezoelectric method. In addition, a large inkjet printer, specifically, an inkjet printer intended for performing printing on products produced on an industrial line can also be preferably used.

In a case where the ink for a decorative layer is an active energy ray curable ink set, a layer formed by printing is cured by irradiation with an active energy ray such as an ultraviolet ray. As a light source of the active energy ray, a high pressure mercury lamp, a metal halide lamp, an LED lamp, or the like can be used. In addition, a wavelength of the active energy ray radiated for curing the layer preferably overlaps with an absorption wavelength of the photopolymerization initiator, and a dominant wavelength of the active energy ray is preferably 350 to 400 nm. An integrated light amount of the active energy ray is preferably in a range of 100 to 2,000 mJ/cm².

In the printing, surface finishing processing such as gloss tone and matte tone can be performed by appropriately selecting ejection conditions and subsequent curing conditions. For example, when the ink is cured after a lapse of time after spreading, the ink becomes glossy, and when the ink droplets are cured in a lens-like state, the ink droplets become matte.

In the coated body of the present invention, the decorative layer has excellent color reproducibility and can also express an image with high sharpness. Here, examples of the image having high sharpness include a red brick pattern, a blue marble pattern, and a portrait.

In the coated body of the present invention, examples of the substrate include plastic substrates such as an epoxy resin, an ABS resin, polycarbonate, polyvinyl chloride, polystyrene, an acrylic resin such as polymethyl methacrylate (PMMA), polyethylene terephthalate (PET), and a polyolefin such as polypropylene (PP), metal substrates such as steel, galvanized steel, tinned steel, stainless steel, a magnesium alloy, aluminum, an aluminum alloy, titanium, and a titanium alloy, inorganic substrates other than metals, such as cement, mortar, concrete, slate, gypsum, calcium silicate, glass, ceramics, calcium carbonate, marble, and artificial marble, wood substrates such as wood, paper substrates, and composite substrates obtained by combining two or more of these substrates. In addition, examples of the composite substrates include composite substrates such as wood fiber-reinforced cement plates, fiber-reinforced cement plates, and fiber-reinforced cement/calcium silicate plates, metal substrates subjected to various surface treatments, for example, oxidation treatments, and plastic substrates whose surfaces are coated with inorganic substances (for example, a glass-coated plastic substrate).

The substrate has various shapes, and examples of the substrate include a two-dimensional substrate having a film shape, a sheet shape, a plate shape, or the like, and a three-dimensional substrate that is a three-dimensional object having a complicated shape. A surface of the substrate may be smooth or may have irregularities.

The surface of the substrate may be subjected to a pretreatment such as a degreasing treatment, a chemical conversion treatment, or polishing, a sealer, primer coating, or the like.

Specific examples of the substrate include plastic materials such as a vinyl chloride sheet, a tarpaulin, a plastic cardboard, and an acrylic plate; papers such as a coated paper (specifically, a resin-coated paper), an art paper, a cast paper, a lightly coated paper, a fine paper, a synthetic paper, and an inkjet paper; wood-based building materials such as veneer, plywood, a particle board, and a medium density fiberboard (MDF); inorganic building materials such as a ceramic siding board, a flexible board, a calcium silicate board, a gypsum slag perlite board, a wood chip cement board, a pulp cement board, a precast concrete board, an autoclaved lightweight concrete (ALC) board, and a gypsum board; metal building materials such as aluminum, iron, and stainless steel, PCM steel plates, tiles, and glass plates.

The substrate may be a building material such as an exterior material or an interior material. Examples of the exterior building material include building materials used for roofs, walls, and the like, and examples of the interior building material include building materials used for floors, ceilings, walls, and the like.

The coated body of the present invention preferably further comprises an ink receiving layer in addition to the substrate and the decorative layer. By providing the ink receiving layer, fixing of the ink can be improved. In a case where the coated body of the present invention comprises the substrate, the ink receiving layer, and the decorative layer, a surface on which the decorative layer is printed is a surface of the ink receiving layer. That is, in the embodiment, the coated body comprises the decorative layer formed on the ink receiving layer. In addition, the ink receiving layer may be formed directly on the substrate, or an additional layer (for example, a layer for improving fixing of the ink receiving layer to the substrate) may be present between the substrate and the ink receiving layer.

In the coated body of the present invention, the ink receiving layer preferably contains a crosslinked resin. Due to the crosslinked resin, excessive penetration of the ink into the ink receiving layer can be prevented, and the color developability can be increased

In a case where the coated body of the present invention comprises the ink receiving layer, the surface of the ink receiving layer is the surface on which the decorative layer is printed, and thus, an L* value of the surface on which the decorative layer is printed can be adjusted by the ink receiving layer. Examples of a method of adjusting the L* value of the ink receiving layer include selection of a pigment type, adjustment of an average dispersed-particle diameter of a pigment, adjustment of a pigment concentration, and use of a white pigment. In particular, the ink receiving layer preferably contains a white pigment.

In a case where the coated body of the present invention is an exterior building material, the ink receiving layer is preferably formed of an aqueous coating material. The aqueous coating material is preferable from the viewpoint of environmental conservation because it does not contain a volatile organic compound or has a small content of a volatile compound.

The ink receiving layer can be formed by applying a coating material for an ink receiving layer to the surface of the substrate and then forming a film by drying or the like.

The coating material for an ink receiving layer preferably contains an aqueous dispersion of resin particles containing a resin, and in this resin, a resin having a ratio of a structural unit derived from a monomer having a cyclic structure of more than 0 and 28 mass % or less is preferably used.

The resin used for the ink receiving layer is not particularly limited, and examples thereof include a polymer containing a structural unit derived from a monomer having no cyclic structure, and a polymer containing a structural unit derived from a monomer having no cyclic structure and a structural unit derived from a monomer having a cyclic structure. The structural unit derived from a monomer having no cyclic structure and the structural unit derived from a monomer having a cyclic structure may be used alone or in combination of two or more thereof.

Examples of the monomer having a cyclic structure include an alicyclic group-containing unsaturated hydrocarbon, an aromatic ring-containing unsaturated hydrocarbon, an alicyclic group-containing unsaturated carboxylic acid, an alicyclic group-containing unsaturated carboxylic acid ester, an alicyclic group-containing unsaturated carboxylic acid amide, an aromatic ring-containing unsaturated carboxylic acid, an aromatic ring-containing unsaturated carboxylic acid ester, an aromatic ring-containing unsaturated carboxylic acid amide, an alicyclic group-containing alkoxysilane, and an aromatic ring-containing alkoxysilane. The alicyclic group and the aromatic ring may have a hetero atom such as a nitrogen atom or an oxygen atom in the ring, or may have a substituent.

In the resin used for the ink receiving layer, a ratio of the structural unit derived from the monomer having a cyclic structure is preferably more than 0 and 28 mass % or less, more preferably 0.01 to 26 mass %, and still more preferably 0.1 to 25 mass %. The slight presence of the monomer having a cyclic structure can be expected to be effective in adjusting the dot diameter.

The resin used for the ink receiving layer is a polymer preferably containing 25 to 85 mass % of at least one structural unit derived from an ethylenically unsaturated monomer having a solubility parameter of 9.50 to 13.0. The solubility parameter is a measure for determining compatibility, and there are various calculation methods and actual measurement methods. In the present specification, the solubility parameter of a monomer means a solubility parameter calculated by Hoy method based on the structure.

In the present specification, the ethylenically unsaturated monomer refers to a monomer having a double bond in the molecule and causing a polymerization reaction through addition to the double bond. The ethylenically unsaturated monomer is not particularly limited, and examples thereof include monomers having the double bond among the monomers having no cyclic structure and the monomers having a cyclic structure exemplified above.

From the viewpoint of reducing the amount of unreacted monomers, the calculated glass transition temperature of the resin is preferably −15 to 85° C., more preferably −10 to 50° C., and still more preferably −5 to 40° C. When the calculated glass transition temperature is −15° C. or higher, tackiness is less likely to remain after drying. When the calculated glass transition temperature is 85° C. or lower, drying is less likely to be delayed. In the present specification, the calculated glass transition temperature refers to a glass transition temperature calculated by Fox equation.

As a method of preparing an aqueous dispersion of resin particles containing a resin, the aqueous dispersion can be prepared, for example, by subjecting a monomer having no cyclic structure, a combination of a monomer having no cyclic structure and a monomer having a cyclic structure, or the like to emulsion polymerization in an aqueous medium containing water as a main component according to a normal method.

A content of the resin in the ink receiving layer is preferably 10 to 60 mass % and more preferably 20 to 45 mass %. When the content of the resin is 10 to 60 mass %, the monomer of the ink for a decorative layer is less likely to remain in the ink receiving layer after printing of the decorative layer, and adhesion between the ink receiving layer and the decorative layer can be enhanced while maintaining performance excellent in color developability.

The coating material for an ink receiving layer may contain a pigment in addition to the aqueous dispersion. The pigment is not particularly limited, and examples thereof include a coloring pigment (for example, a white pigment), a rust preventive pigment, and an extender pigment generally used in the coating industry.

A content of the pigment in the ink receiving layer is preferably 35 to 85 mass % and more preferably 40 to 75 mass %. When the content of the pigment is 35 to 85 mass %, the monomer of the ink for a decorative layer is less likely to remain in the ink receiving layer after printing of the decorative layer, and adhesion between the ink receiving layer and the decorative layer can be enhanced while maintaining performance excellent in color developability.

The coating material for an ink receiving layer may further contain a film-forming auxiliary agent. From the viewpoint of film formability, a content of the film-forming auxiliary agent is preferably 0 to 10 mass % with respect to the coating material.

In addition to the components described above, additives commonly used in the coating industry, for example, a photopolymerization initiator, a light stabilizer, a polymerization inhibitor, an organic solvent, an antioxidant, a silane coupling agent, a plasticizer, an antifoaming agent, a surface conditioner, a wet dispersant, a rheology control agent, an ultraviolet absorber, a viscosity modifier, a preservative, and the like may be appropriately selected and blended in the coating material for an ink receiving layer within a range not impairing the object of the present invention.

A thickness of the ink receiving layer is, for example, 10 to 50 μm. The ink receiving layer may be one layer or a plurality of layers. Here, in a case where the ink receiving layer is composed of a plurality of layers, the thickness of the ink receiving layer is the total thickness of the plurality of ink receiving layers.

The coated body of the present invention preferably further comprises a clear layer. The clear layer is preferably formed on the decorative layer from the viewpoint of protecting the decorative layer. The clear layer means a layer having a visible light transmittance of 60% or more in a case where the thickness is 10 μm. By using a layer having high visible light transmittance, the decorative layer can be protected without impairing the design of the decorative layer.

The visible light transmittance means the total light transmittance in a visible region (360 nm to 750 nm), and can be measured in accordance with JIS K 7375:2008.

### EXAMPLES

Hereinafter, the present invention will be described in more detail with reference to Examples, but the present invention is not limited to the following Examples.

### Synthesis Example 1

Into a 5-necked flask equipped with a stirrer, a reflux condenser, a thermometer, a dropping device, and a nitrogen introducing tube, 386 parts by mass of deionized water and 10 parts by mass of polyoxyethylene-1-(allyloxymethyl)alkyl ether sulfate ester ammonium salt (manufactured by DKS Co., Ltd.; AQUALON KH10) were charged, and the temperature was increased to 80° C. while the inside of the reactor was replaced with nitrogen. Thereafter, 4 parts by mass of ammonium persulfate was added to the reactor, and then 97 parts by mass of cyclohexyl methacrylate, 531 parts by mass of methyl methacrylate, 299 parts by mass of 2-ethylhexyl acrylate, 39 parts by mass of methacrylic acid, and 579 parts by mass of ion exchange water that were stirred and mixed in a separate container in advance were continuously added dropwise for 3.5 hours. Thereafter, aging was performed at 80° C. for 5 hours while continuing stirring, and then cooling was performed to room temperature. Thereafter, neutralization was performed up to pH 9 using a 28 mass % ammonia aqueous solution to obtain a resin particle aqueous dispersion 1 having a resin content of 50 mass %.

### Synthesis Example 2

In the same manner as that of Synthesis Example 1, synthesis was performed with the monomer composition in Table 1 to obtain a resin particle aqueous dispersion 2 having a resin content of 50 mass %.

TABLE 1

| | | | Synthesis Example | |
|---|---|---|---|---|
| | | | 1 | 2 |
| | | | Resin particle aqueous | |
| | | SP | dispersion | |
| Monomer used | | value | 1 | 2 |
| Cyclic structure- | CHMA | 9.48 | 97 | 0 |
| containing monomer | ST | 9.43 | 0 | 97 |
| Other monomers | MMA | 9.53 | 531 | 466 |
| | EHA | 9.20 | 299 | 305 |
| | MAA | 9.15 | 39 | 39 |
| | DAAM | 11.08 | | 49 |
| | KBM503 ※ 1 | 9.48 | 0 | 10 |

| | | |
|---|---|---|
| Total parts by mass | 966 | 966 |
| Derived from cyclic structure- | 10 | 10 |
| containing monomer in resin | | |
| Derived from monomer having SP | 55 | 53 |
| value of 9.5 to 13.0 | | |
| Presence or absence of crosslinking | Absence | Presence |
| between molecules of resin | | |

* 1 For silane coupling agent KBM503, only an SP value of an organic group is shown.
CHMA: cyclohexyl methacrylate
ST: styrene
MMA: methyl methacrylate
EHA: 2-ethylhexyl acrylate
MAA: methacrylic acid
DAAM: diacetone acrylamide
KBM503: 3-methacryloyloxypropyltrimethoxysilane (manufactured by Shin-Etsu Chemical Co., Ltd.)

In Table 1, the “derived from a cyclic structure-containing monomer in a resin” is a proportion (mass %) of a structural unit derived from a monomer having a cyclic structure in a resin. The “derived from a monomer having an SP value of 9.5 to 13.0” is a proportion (mass %) of a structural unit derived from a monomer having a solubility parameter of 9.50 to 13.0 in the resin.

(Preparation Example of Coating Material for Ink Receiving Layer)

The raw materials and titania beads were mixed according to the blending shown in Table 2 and then dispersed with a bead mill. After the dispersion, the titania beads were removed to prepare coating materials A to E for an ink receiving layer.

TABLE 2

| | | Coating material for ink receiving layer | | | | |
|---|---|---|---|---|---|---|
| | | A | B | C | D | E |
| Coloring | White pigment¹⁾ | 16.902 | 15.131 | 14.026 | 13.456 | 14.026 |
| pigment | Yellow pigment²⁾ | 0.091 | 0.011 | 0.091 | 0.091 | 0.091 |
| | Red pigment³⁾ | 0.003 | 0.034 | 0.034 | 0.034 | 0.034 |
| | Black pigment⁴⁾ | 0.003 | 1.823 | 2.849 | 3.418 | 2.849 |
| Extender | Extender pigment⁵⁾ | 11.0 | 11.0 | 11.0 | 11.0 | 11.0 |
| pigment | | | | | | |
| Resin | Resin particle aqueous | 32.0 | 32.0 | 32.0 | 32.0 | |
| composition | dispersion 1 | | | | | |
| | Resin particle aqueous | | | | | 32.0 |
| | dispersion 2 | | | | | |
| Water | | 30.0 | 30.0 | 30.0 | 30.0 | 30.0 |
| Film-forming | Ethylene glycol | 4.8 | 4.8 | 4.8 | 4.8 | 4.8 |
| auxiliary agent | monobutyl ether | | | | | |
| Crosslinking | Adipic acid dihydrazide | | | | | 0.3 |
| agent | | | | | | |
| Additive | Antifoaming agent⁶⁾ | 0.3 | 0.3 | 0.3 | 0.3 | 0.3 |
| | Viscosity modifier⁷⁾ | 3.3 | 3.3 | 3.3 | 3.3 | 3.3 |
| | Preservative⁸⁾ | 0.4 | 0.4 | 0.4 | 0.4 | 0.4 |
| | Ultraviolet absorber⁹⁾ | 0.5 | 0.5 | 0.5 | 0.5 | 0.5 |
| | Light stabilizer¹⁰⁾ | 0.5 | 0.5 | 0.5 | 0.5 | 0.5 |
| Total | parts by mass | 100 | 100 | 100 | 100 | 100 |

| | | | | | |
|---|---|---|---|---|---|
| Presence or absence of crosslinking | Absence | Absence | Absence | Absence | Presence |
| between particles | | | | | |

¹⁾Titanium oxide, density 3.8 g/cm³, (TITONER-62N, manufactured by SAKAI CHEMICAL INDUSTRY CO., LTD.)
²⁾Yellow iron oxide, density 4.1 g/cm³, (TAROXLL-XLO, manufactured by Titan Kogyo, Ltd.)
³⁾Ferric oxide red, density 5.2 g/cm³, (130ED, manufactured by TODA KOGYO CORP.)
⁴⁾Carbon black, density 2.0 g/cm³, (Asahi #50, manufactured by Asahi Carbon Co., Ltd.)
⁵⁾Heavy calcium carbonate, density 2.7 g/cm³, average particle diameter 2 μm (manufactured by Maruo Calcium Co., Ltd.)
⁶⁾SN deformer 1316 (manufactured by SAN NOPCO LIMITED)
⁷⁾ASE-60 (manufactured by Rohm and Haas Company)
⁸⁾Proxel A M (manufactured by Arch Chemical, Inc.)
⁹⁾TINUVIN1130 (BASF SE)
¹⁰⁾Sanol LS-292 (manufactured by Sankyo Kasei Co., Ltd.)

(Preparation Example of Ink)

The raw materials and zirconia beads (φ 0.65 mm) were mixed according to the formulation shown in Tables 3 to 5 and then dispersed with a bead mill. The amount of each component in Tables 3 to 5 is shown in parts by mass. After the dispersion, the zirconia beads were removed to prepare inkjet inks (cyan inks C1 to C8, yellow inks Y1 to Y8, and magenta inks M1 to M10). Next, ink sets were prepared by combining the inks shown in Tables 6 to 19.

TABLE 3

| | | | C1 | C2 | C3 | C4 | C5 | C6 | C7 | C8 |
|---|---|---|---|---|---|---|---|---|---|---|
| Composition | Polymerizable | Photopolymerizable compound A¹⁾ | 61 | 54 | 54 | 54 | 47 | 34 | 22 | 33 |
| | compound | Photopolymerizable compound B²⁾ | | | | | | | 25 | |
| | | Photopolymerizable compound C³⁾ | 10 | 10 | 10 | 10 | 10 | 10 | 10 | 10 |
| | | Photopolymerizable compound D⁴⁾ | 10 | 10 | 10 | 10 | 10 | 10 | 10 | 10 |
| | | Photopolymerizable compound E⁵⁾ | 5 | 5 | 5 | 5 | 5 | 5 | 5 | 5 |
| | Silane compound | Silane coupling agent⁶⁾ | 5 | 5 | 5 | 5 | 5 | 5 | 5 | 5 |
| | Photopolymerization | Monoacylphosphine oxide⁷⁾ | 4 | 4 | 4 | 4 | 4 | 4 | 4 | 4 |
| | initiator | | | | | | | | | |
| | Pigment | Cobalt pigment A | 3 | 10 | | | | | | |
| | | Phthalocyanine pigment | | | 10 | | | | | |
| | | Cobalt pigment B | | | | 10 | 15 | 30 | 15 | 25 |
| | | Iron oxide pigment A | | | | | | | | |
| | | Quinacridone pigment | | | | | | | | |
| | | Iron oxide pigment B | | | | | | | | |
| | | Iron oxide pigment C | | | | | | | | |
| | | Iron oxide pigment D | | | | | | | | |
| | | Iron oxide pigment E | | | | | | | | |
| | | Iron hydroxide pigment A | | | | | | | | |
| | | Azonickel complex pigment | | | | | | | | |
| | | Iron hydroxide pigment B | | | | | | | | |
| | | Titanium oxide pigment | | | | | 2 | | 2 | 6 |
| | Pigment dispersant | Pigment dispersant⁸⁾ | 1 | 1 | 1 | 1 | 1 | 1 | 1 | 1 |
| | Surface conditioner | Surface conditioner⁹⁾ | 1 | 1 | 1 | 1 | 1 | 1 | 1 | 1 |

| L value | White background portion | 91 | 80 | 77 | 75 | 59 | 61 | 59 | 48 |
|---|---|---|---|---|---|---|---|---|---|
| | Black background portion | 5 | 14 | 19 | 24 | 31 | 29 | 33 | 39 |

| | | | | | | | | |
|---|---|---|---|---|---|---|---|---|
| Contrast ratio % | 5 | 17 | 25 | 32 | 53 | 48 | 56 | 81 |
| Hue angle ∠H° | 241 | 245 | 240 | 258 | 263 | 268 | 263 | 270 |
| Amount of magnetite in iron oxide pigment (mass %) | — | — | — | — | — | — | — | — |

TABLE 4

| | | | M1 | M2 | M3 | M4 | M5 | M6 | M7 | M8 | M9 | M10 |
|---|---|---|---|---|---|---|---|---|---|---|---|---|
| Composition | Polymerizable | Photopolymerizable compound A¹⁾ | 61 | 58 | 54 | 54 | 22 | 44 | 24 | 38 | 49 | 49 |
| | compound | Photopolymerizable compound B²⁾ | | | | | 25 | | 25 | | | |
| | | Photopolymerizable compound C³⁾ | 10 | 10 | 10 | 10 | 10 | 10 | 10 | 10 | 10 | 10 |
| | | Photopolymerizable compound D⁴⁾ | 10 | 10 | 10 | 10 | 10 | 10 | 10 | 10 | 10 | 10 |
| | | Photopolymerizable compound E⁵⁾ | 5 | 5 | 5 | 5 | 5 | 5 | 5 | 5 | 5 | 5 |
| | Silane compound | Silane coupling agent⁶⁾ | 5 | 5 | 5 | 5 | 5 | 5 | 5 | 5 | 5 | 5 |
| | Photopolymerization | Monoacylphosphine oxide⁷⁾ | 4 | 4 | 4 | 4 | 4 | 4 | 4 | 4 | 4 | 4 |
| | initiator | | | | | | | | | | | |
| | Pigment | Cobalt pigment A | | | | | | | | | | |
| | | Phthalocyanine pigment | | | | | | | | | | |
| | | Cobalt pigment B | | | | | | | | | | |
| | | Iron oxide pigment A | | | | | | | | | | 15 |
| | | Quinacridone pigment | | | 10 | | | | | | | |
| | | Iron oxide pigment B | | | | | | | | | 15 | |
| | | Iron oxide pigment C | 3 | 6 | | | | | | | | |
| | | Iron oxide pigment D | | | | 10 | 15 | 20 | | 20 | | |
| | | Iron oxide pigment E | | | | | | | 15 | | | |
| | | Iron hydroxide pigment A | | | | | | | | | | |
| | | Azonickel complex pigment | | | | | | | | | | |
| | | Iron hydroxide pigment B | | | | | | | | | | |
| | | Titanium oxide pigment | | | | | 2 | | | 6 | | |
| | Pigment dispersant | Pigment dispersant⁸⁾ | 1 | 1 | 1 | 1 | 1 | 1 | 1 | 1 | 1 | 1 |
| | Surface conditioner | Surface conditioner⁹⁾ | 1 | 1 | 1 | 1 | 1 | 1 | 1 | 1 | 1 | 1 |

| L value | White background portion | 80 | 66 | 65 | 59 | 53 | 54 | 54 | 48 | 55 | 55 |
|---|---|---|---|---|---|---|---|---|---|---|---|
| | Black background portion | 6 | 20 | 19 | 29 | 33 | 32 | 31 | 39 | 31 | 30 |

| | | | | | | | | | | |
|---|---|---|---|---|---|---|---|---|---|---|
| Contrast ratio % | 8 | 30 | 29 | 49 | 62 | 59 | 57 | 81 | 56 | 55 |
| Hue angle [symbol] H° | 65 | 61 | 346 | 37 | 36 | 34 | 37 | 36 | 35 | 34 |
| Amount of magnetite in iron oxide pigment (mass %) | 4.6 | 4.6 | — | 2.2 | 2.2 | 2.2 | 1.1 | 2.2 | 5.5 | 7.9 |

TABLE 5

| | | | Y1 | Y2 | Y3 | Y4 | Y5 | Y6 | Y7 | Y8 |
|---|---|---|---|---|---|---|---|---|---|---|
| Composition | Polymerizable | Photopolymerizable compound A¹⁾ | 61 | 54 | 54 | 54 | 47 | 34 | 22 | 38 |
| | compound | Photopolymerizable compound B²⁾ | | | | | | | 25 | |
| | | Photopolymerizable compound C³⁾ | 10 | 10 | 10 | 10 | 10 | 10 | 10 | 10 |
| | | Photopolymerizable compound D⁴⁾ | 10 | 10 | 10 | 10 | 10 | 10 | 10 | 10 |
| | | Photopolymerizable compound E⁵⁾ | 5 | 5 | 5 | 5 | 5 | 5 | 5 | 5 |
| | Silane compound | Silane coupling agent⁶⁾ | 5 | 5 | 5 | 5 | 5 | 5 | 5 | 5 |
| | Photopolymerization | Monoacylphosphine oxide⁷⁾ | 4 | 4 | 4 | 4 | 4 | 4 | 4 | 4 |
| | initiator | | | | | | | | | |
| | Pigment | Cobalt pigment A | | | | | | | | |
| | | Phthalocyanine pigment | | | | | | | | |
| | | Cobalt pigment B | | | | | | | | |
| | | Iron oxide pigment A | | | | | | | | |
| | | Quinacridone pigment | | | | | | | | |
| | | Iron oxide pigment B | | | | | | | | |
| | | Iron oxide pigment C | | | | | | | | |
| | | Iron oxide pigment D | | | | | | | | |
| | | Iron oxide pigment E | | | | | | | | |
| | | Iron hydroxide pigment A | 3 | 10 | | | | | | |
| | | Azonickel complex pigment | | | 10 | | | | | |
| | | Iron hydroxide pigment B | | | | 10 | 15 | 30 | 15 | 20 |
| | | Titanium oxide pigment | | | | | 2 | | 2 | 6 |
| | Pigment dispersant | Pigment dispersant⁸⁾ | 1 | 1 | 1 | 1 | 1 | 1 | 1 | 1 |
| | Surface conditioner | Surface conditioner⁹⁾ | 1 | 1 | 1 | 1 | 1 | 1 | 1 | 1 |

| L value | White background portion | 91 | 86 | 87 | 84 | 66 | 75 | 65 | 48 |
|---|---|---|---|---|---|---|---|---|---|
| | Black background portion | 7 | 22 | 29 | 32 | 37 | 34 | 37 | 39 |

| | | | | | | | | |
|---|---|---|---|---|---|---|---|---|
| Contrast ratio % | 7 | 26 | 33 | 38 | 56 | 45 | 57 | 81 |
| Hue angle [symbol] H° | 88 | 89 | 96 | 81 | 82 | 80 | 86 | 86 |
| Amount of magnetite in iron oxide pigment (mass %) | — | — | — | — | — | — | — | — |

(Polymerizable Compound)
¹⁾Photopolymerizable compound A: phenoxyethyl acrylate (manufactured by Kyoeisha Chemical Co., Ltd.)
²⁾Photopolymerizable compound B: ethoxy diethylene glycol acrylate (manufactured by Kyoeisha Chemical Co., Ltd.)
³⁾Photopolymerizable compound C: acryloyl morpholine (manufactured by KJ Chemicals Corporation)
⁴⁾Photopolymerizable compound D: 4-hydroxybutyl acrylate (manufactured by OSAKA ORGANIC CHEMICAL INDUSTRY LTD.)
⁵⁾Photopolymerizable compound E: trimethylolpropane triacrylate (manufactured by Kyoeisha Chemical Co., Ltd.)
(Silane Compound)
⁶⁾Silane coupling agent: 3-glycidoxypropyltrimethoxysilane (manufactured by Shin-Etsu Chemical Co., Ltd.)
Photopolymerization Initiator
⁷⁾Monoacylphosphine oxide: IRGACURE TPO (trade name, manufactured by BASF SE)

(Pigment)
Cobalt pigment A: DAIPYROXIDE™ Blue #3490 (C.I. Pigment Blue 28, manufactured by DAINICHISEIKA COLOR & CHEM MFG CO., LTD.)
Phthalocyanine pigment: LIONOGENBLUE 7921 (C.I. Pigment Blue 15:4, manufactured by Toyocolor Co., Ltd.)
Cobalt pigment B: DAIPYROXIDE Blue #9410 (C.I. Pigment Blue 28, manufactured by DAINICHISEIKA COLOR & CHEM MFG CO., LTD.)
Iron oxide pigment A: C.I. Pigment Red 101, manufactured by TODA KOGYO CORP., magnetite content: 7.9 mass %
Quinacridone pigment: FASTGEN SUPER MAGENTA RGT (C.I. Pigment Red 122, manufactured by DIC Corporation)
Iron oxide pigment B: C.I. Pigment Red 101, magnetite content: 5.5 mass %
Iron oxide pigment C: C.I. Pigment Red 101, magnetite content: 4.6 mass %
Iron oxide pigment D: C.I. Pigment Red 101, magnetite content: 2.2 mass %
Iron oxide pigment E: C.I. Pigment Red 101, magnetite content: 1.1 mass %
Iron hydroxide pigment A: SICOTRANS YELLOW L1916 (C.I. Pigment Yellow 42, manufactured by DIC Corporation)
Azonickel complex pigment: yellow pigment LEVA SCREEN YELLOW G01 (C.I. Pigment Yellow 150, manufactured by Lanxess AG)
Iron hydroxide pigment B: TAROX synthetic iron oxide HY-100 (C.I. Pigment Yellow 42, manufactured by Titan Kogyo, Ltd.)
Titanium oxide pigment: TITONE R-11P (C.I. Pigment White 6, manufactured by Sakai Chemical Industry Co., Ltd.)

(Pigment Dispersant)

8) Pigment dispersant: TEGO Dispers 685 (trade name, manufactured by Evonik Industries)

(Surface Conditioner)

9) Surface conditioner: TEGO Glide 410 (trade name, manufactured by Evonik Industries)

The item “contrast ratio %” in the table indicates a contrast ratio (%) of a dried film having a thickness of 10 μm determined from an L* value of an ink dried film printed on a white background portion and a black background portion of a hiding power test paper. In the item “hue angle ∠H°”, a hue angle (°) of the dried film having a thickness of 10 μm formed from the ink is shown.

(Creation Example of Calibration Curve for Determining Content of Magnetite in Iron Oxide Pigment)

A reagent of diiron trioxide (iron(III) oxide (ferric oxide), Cica special grade, manufactured by Kanto Chemical Co., Inc.) and a reagent of magnetite (iron(II,III) oxide, Cica first grade, manufactured by Kanto Chemical Co., Inc.) were mixed to prepare 10 types of mixtures having contents of magnetite of 10 mass %, 9 mass %, 8 mass %, 7 mass %, 6 mass %, 5 mass %, 4 mass %, 3 mass %, 2 mass %, and 1 mass %.

For the reagent used of diiron trioxide, an X-ray diffraction pattern was obtained by measurement in a fluorescence removal mode for 15 minutes using an X-ray diffractometer (AERIS, manufactured by PANalytical B. V.), and it was confirmed that there was no peak at the position of the first peak of magnetite (35.62° 2θ, ICDD:01-084-9337).

X-ray diffraction patterns of the prepared 10 mixtures were obtained by measurement for 15 minutes in a fluorescence removal mode using an X-ray diffractometer (AERIS, manufactured by PANalytical B. V.). Next, in each of the obtained X-ray diffraction patterns of the mixtures, a peak intensity value (A) of the first peak of diiron trioxide and a peak intensity value (B) of a position of the first peak of magnetite at the position of the first peak of diiron trioxide (33.15° 2θ, ICDD:01-085-0599) and the position of the first peak of magnetite (35.62° 2θ, ICDD:01-084-9337) were read, and a peak intensity ratio (B/A) of the two values was calculated.

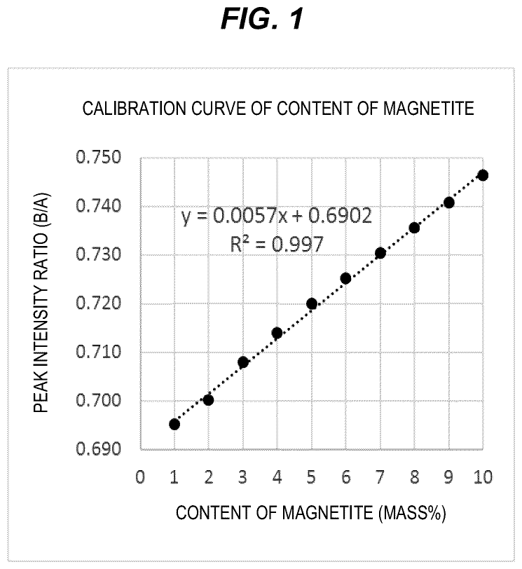

Using Excel of Microsoft Corporation, the calibration curve shown in FIG. 1 was created by plotting on a graph in which a vertical axis (y axis) is the peak intensity ratio (B/A) and a horizontal axis (x axis) is the amount (mass %) of magnetite with respect to 100 mass % of the mixture and drawing an approximate straight line of the plotted 10 points. FIG. 1 illustrates a calibration curve for determining a content of magnetite represented by y=0.0057x+0.6902.

(Content of Magnetite in Iron Oxide Pigment A)

The X-ray diffraction pattern of the iron oxide pigment A was measured under the same conditions as those in the creation of the calibration curve, and it was confirmed from the calibration curve that the content of magnetite was 7.9 mass %.

(Preparation Example of Iron Oxide Pigment B)

The iron oxide pigment A was dispersed in methyl ethyl ketone to prepare a dispersion.

Next, the dispersion was passed once through a stainless steel wire mesh having magnetism and having a neodymium magnet (240 mT) adsorbed thereon (KMG mesh, manufactured by Kansai Wire Netting Co., Ltd.) to prepare an iron oxide pigment B.

The X-ray diffraction pattern of the iron oxide pigment B was measured under the same conditions as those in the creation of the calibration curve, and it was confirmed from the calibration curve that the content of magnetite was 5.5 mass %.

(Preparation Example of Iron Oxide Pigment C)

An iron oxide pigment C was prepared in the same manner as that of Preparation Example of the iron oxide pigment B, except that the number of times of passing the dispersion through the stainless steel wire mesh having magnetism and having a neodymium magnet (240 mT) adsorbed thereon was changed to two.

The X-ray diffraction pattern of the iron oxide pigment C was measured under the same conditions as those in the creation of the calibration curve, and it was confirmed from the calibration curve that the content of magnetite was 4.6 mass %.

(Preparation Example of Iron Oxide Pigment D)

An iron oxide pigment D was prepared in the same manner as that of Preparation Example of the iron oxide pigment B, except that the number of times of passing the dispersion through the stainless steel wire mesh having magnetism and having a neodymium magnet (240 mT) adsorbed thereon was changed to five.

The X-ray diffraction pattern of the iron oxide pigment D was measured under the same conditions as those in the creation of the calibration curve, and it was confirmed from the calibration curve that the content of magnetite was 2.2 mass %.

(Preparation Example of Iron Oxide Pigment E)

An iron oxide pigment E was prepared in the same manner as that of Preparation Example of the iron oxide pigment B, except that the number of times of passing the dispersion through the stainless steel wire mesh having magnetism and having a neodymium magnet (240 mT) adsorbed thereon was changed to ten.

The X-ray diffraction pattern of the iron oxide pigment E was measured under the same conditions as those in the creation of the calibration curve, and it was confirmed from the calibration curve that the content of magnetite was 1.1 mass %.

### Experimental Examples 1 to 26

The following evaluations were performed using ink sets (Experimental Examples 1 to 26) of combinations shown in Tables 6 to 10.

Hereinafter, a preparation method of a printed material for evaluation, a method of measuring a contrast ratio and a hue angle, an evaluation method of color reproducibility of a mixed color, mixed color gradation characteristics, ink ejection performance, visibility, and color developability, and evaluation criteria will be described.

<Preparation Method 1 of Printed Material for Evaluation>

An inkjet printer equipped with an inkjet head (KM1024-LHB set) manufactured by Konica Minolta, Inc. was used, the inkjet printer was filled with each ink, and then a single color solid image of each ink was printed on a white background portion and a black background portion on a hiding power test paper (JIS standard product). In addition, in the case of color mixing, single color solid images were adjusted at a CMY printing density ratio corresponding to each evaluation, and printing was performed by superimposing the adjusted images on the white background portion and the black background portion on the hiding power test paper.

After the printing, the ink was cured using a metal halide lamp to obtain an ink dried film having a dried film thickness of 10 μm.

The dried film thickness of the ink dried film was measured with a micrometer (MDC-25MJ, manufactured by Mitutoyo Corporation).

<Method of Measuring Contrast Ratio>

An L* value of the ink dried film on each of the white background portion and the black background portion of the hiding power test paper was measured using a spectrophotometer (SpectroEye, manufactured by X-Rite, Inc.) for the printed material (ink dried film thickness of 10 μm) prepared in <Preparation Method 1 of Printed Material for Evaluation>. The obtained value was applied to the following Expression (7), and the contrast ratio of each ink was calculated.

Contrast ratio (%)=100×Lb/Lw Expression (7)

The results of the contrast ratios of the respective inks in a single color are shown in Tables 3 to 5. In addition, “difference in contrast ratio (maximum value)” shown in Tables 6 to 10 indicates a difference in contrast ratio determined by subtracting the maximum value and the minimum value from the contrast ratios indicated by the respective inks in the ink set. When the difference in the contrast ratio (maximum value) is 25% or less, all of Relational Expressions (1) to (3) are satisfied.

<Method of Measuring Hue Angle ∠H°>

A single color solid image was printed on a white background portion of a hiding power test paper as described in <Preparation Method 1 of Printed Material for Evaluation>, and a hue angle ∠H° of each of the prepared ink dried films of single color and mixed color each having a film thickness of 10 μm was measured using a spectrophotometer (SpectroEye, manufactured by X-Rite, Inc.). The results of the hue angle ∠H° in the single color are shown in Tables 3 to 5, and the results of the hue angle ∠H° in the mixed color are shown in Tables 6 to 10.

<Evaluation Method 1 of Color Reproducibility of Mixed Color>

A mixed color printed material was prepared at the printing density ratio (volume ratio) shown in “1” in Tables 6 to 10, and the color reproducibility of the mixed color was evaluated from a difference (x) between an actual measurement value of a hue angle of each mixed color printed material and a theoretical value of a hue angle calculated from a colorimetric value of each single color of CMY. The theoretical value of the hue angle can be calculated by Expression (10) or (11) using an a*_{(CMY)} value and a b*_{(CMY)} value determined from Expressions (8) and (9).

a*_{(CMY)} value=a_{C}×density ratio of C+a_{M}×density ratio of M+a_{Y}×density ratio of Y Expression (8)

b*_{(CMY)} value=b_{C}×density ratio of C+b_{M}×density ratio of M+b_{Y}×density ratio of Y Expression (9)

In Expression (8), the a*_{(CMY)} value is a theoretical value of a* of the mixed color printed material calculated from the colorimetric value of each single color of CMY, a_{C} is an a* value of a cyan ink dried film measured using a spectrophotometer (SpectroEye, manufactured by X-Rite, Inc.) for a single color solid image prepared on a white background portion of a hiding power test paper in <Preparation Method 1 of Printed Material for Evaluation>, a_{M} is an a value of a magenta ink dried film measured using a spectrophotometer (SpectroEye, manufactured by X-Rite, Inc.) for a single color solid image prepared on a white background portion of a hiding power test paper in <Preparation Method 1 of Printed Material for Evaluation>, a_{Y} is an a* value of a yellow ink dried film measured using a spectrophotometer (SpectroEye, manufactured by X-Rite, Inc.) for a single color solid image prepared on a white background portion of a hiding power test paper in <Preparation Method 1 of Printed Material for Evaluation>, and density ratios of C, M, and Y are density ratios (vol %) of the cyan ink, the magenta ink, and the yellow ink, respectively.

In Expression (9), the b*_{(CMY)} value is a theoretical value of b* of the mixed color printed material calculated from the colorimetric value of each single color of CMY, b_{C} is a b* value of a cyan ink dried film measured using a spectrophotometer (SpectroEye, manufactured by X-Rite, Inc.) for a single color solid image prepared on a white background portion of a hiding power test paper in <Preparation Method 1 of Printed Material for Evaluation>, b_{M} is a b* value of a magenta ink dried film measured using a spectrophotometer (SpectroEye, manufactured by X-Rite, Inc.) for a single color solid image prepared on a white background portion of a hiding power test paper in <Preparation Method 1 of Printed Material for Evaluation>, b_{Y} is a b* value of a yellow ink dried film measured using a spectrophotometer (SpectroEye, manufactured by X-Rite, Inc.) for a single color solid image prepared on a white background portion of a hiding power test paper in <Preparation Method 1 of Printed Material for Evaluation>, and density ratios of C, M, and Y are density ratios (vol %) of the cyan ink, the magenta ink, and the yellow ink, respectively.

h=tan⁻¹(b*_{(CMY)} value/a*_{(CMY)} value)+180°(a*_{(CMY)} value<0) Expression (10)

h=tan⁻¹(b*_{(CMY)} value/a*_{(CMY)} value)+360°(a*_{(CMY)} value>0) Expression (11)

h=90°(a*_{(CMY)} value=0,b*_{(CMY)} value>0), h=270°(a*_{(CMY)} value=0, b*_{(CMY)} value<0)

When a*_{(CMY)} value<0, the theoretical value (°) of the hue angle is determined using Expression (10), and when a*_{(CMY)} value>0, the theoretical value (°) of the hue angle is determined using Expression (11). When a*_{(CMY)} value=0, the theoretical value (°) of the hue angle is 90° (b*_{(CMY)} value>0), or the theoretical value (°) of the hue angle is 270° (b*_{(CMY)} value<0).

In Expressions (10) and (11), h is a theoretical value (°) of the hue angle of the mixed color printed material calculated from the colorimetric value of each single color of CMY, the a*_{(CMY)} value is an a*_{(CMY)} value determined from Expression (8), and the b*_{(CMY)} value is a b*_{(CMY)} value determined from Expression (9).

<Evaluation 1 of Color Reproducibility of Mixed Color>

Each of mixed color printed materials was prepared for each of the ink sets shown in the tables at the printing density ratios (volume ratios) of the three patterns shown as “1” in Tables 6 to 10, and x calculated for each of the mixed color printed materials according to <Evaluation Method 1 of Color Reproducibility of Mixed Color> was shown in Tables 6 to 10. In addition, the color reproducibility of the mixed color was evaluated for each ink set by applying the calculated x to the following evaluation criteria. The evaluation results of the color reproducibility of the mixed color are shown in Tables 6 to 10.

When the result is ⊙, it is possible to reproduce the mixed color close to the ideal, and the color reproduction region is wide. When the result is ◯, although the reproducibility is not as high as ⊙, it is possible to practically sufficiently reproduce the mixed color. When the result is Δ, although expression of the mixed color is possible, the influence of the specific color is large, and the mixed color reproduction region is also narrowed. When the result is x, the influence of the specific color is large, and expression of the mixed color cannot be performed.

(Evaluation Criteria)

⊙=The x values calculated for the respective mixed color printed materials all satisfy 0≤x≤10.

◯=The x values calculated for the respective mixed color printed materials all satisfy x≤20, and at least some x values satisfy 10<x≤20.

Δ=The x values calculated for the respective mixed color printed materials all satisfy x≤30, and at least some x values satisfy 20<x≤30.

x=Some or all the x values calculated for the respective mixed color printed materials satisfy x>30.

<Evaluation Method of Gradation Characteristics of Mixed Color>

Mixed color printed materials were prepared with the combinations of the colors shown in “2” and “3” in Tables 6 to 10 and the printing density ratios (volume ratios), and the hue angle and the L* value were measured. A difference between the maximum change amount of the hue angle (y described below) and the L* value (z described below) was obtained for each combination of colors.

y can be calculated by Expression (12) using the minimum value (∠H°_{MIN}) and the maximum value (∠H°_{MAX}) among the hue angles of the ink dried films measured using a spectrophotometer (SpectroEye, manufactured by X-Rite, Inc.) for the mixed color printed material prepared on the white background portion of the hiding power test paper in <Preparation method 1 of Printed Material for Evaluation>.

y=∠H°_{MAX}−∠H°_{MIN} Expression (12)

An L* value (L₀) of the white background portion of the hiding power test paper, an L* value (L_{25:25}) of the printing density ratio pattern 25:25 prepared on the white background portion of the hiding power test paper, and an L* value (L_{50:50}) of the printing density ratio pattern 50:50 prepared on the white background portion were determined, and then z can be calculated by Expression (13). The L* value is calculated by measuring the L* value of each of the mixed color printed materials having the printing density ratio pattern prepared on the white background portion of the hiding power test paper in <Preparation Method 1 of Printed Material for Evaluation> and the white background portion of the hiding power test paper with a spectrophotometer (SpectroEye, manufactured by X-Rite, Inc.).

z=|(L_{25:25}−L₀)−(L_{50:50}−L_{25:25})| Expression (13)

<Evaluation of Gradation Characteristics 1 of Mixed Color>

A mixed color printed material was prepared for each combination of the respective colors shown in “2” in Tables 6 to 10 with each of the ink sets shown in the tables, and y calculated according to <Evaluation Method of Gradation Characteristics of Mixed Color> is shown in the tables. In addition, the gradation characteristics were evaluated by applying the calculated y to the following evaluation criteria. The results are shown in Tables 6 to 10.

When the result is ◯, it is a combination of inks that can express dark to light colors while exhibiting a substantially constant hue angle. When the result is Δ, the hue angle indicates an intermittent value, and does not have a smooth mixed color gradation. When the result is x, the graininess stands out as the printing density ratio decreases, and it is difficult to reproduce the color of the mixed color as well as the gradation.

(Evaluation Criteria)

◯=The y values calculated for the respective mixed color printed materials all satisfy 0≤y≤15.

Δ=The y values calculated for the respective mixed color printed materials all satisfy y≤25, and at least some y values satisfy 15<y≤25.

x=Some or all the y values calculated for the respective mixed color printed materials satisfy y>25.

<Evaluation of Gradation Characteristics 2 of Mixed Color>

A mixed color printed material was prepared for each combination of the respective colors shown in “3” in Tables 6 to 10 with each of the ink sets shown in Tables 6 to 10, and z calculated according to <Evaluation Method of Gradation Characteristics of Mixed Color> is shown in Tables 6 to 10. In addition, the gradation characteristics were evaluated by applying the calculated z to the following evaluation criteria. The results are shown in Tables 6 to 10.

When the result is ◯, since the ground is hidden according to the printing density ratio, the combination of inks capable of expressing dark to light colors is obtained. When the result is Δ, a sudden change in hiding is exhibited, and a smooth mixed color gradation is not obtained. When the result is x, the graininess stands out as the printing density ratio decreases, and it is difficult to reproduce the color of the mixed color as well as the gradation.

(Evaluation Criteria)

◯=The z values calculated for the respective mixed color printed materials all satisfy 0≤z≤15.

Δ=The z values calculated for the respective mixed color printed materials all satisfy z≤25, and at least some z values satisfy 15<z≤25.

x=Some or all the z values calculated for the respective mixed color printed materials satisfy z>25.

<Evaluation of Ink Ejection Performance>

Using a droplet flying observation apparatus equipped with an inkjet head KM1024-LHB manufactured by Konica Minolta, Inc., ejection suitability of each of CMY inks was evaluated for each of the ink sets shown in Tables 6 to 10. The results are shown in Tables 6 to 10. The evaluation criteria are as follows, and when the result is ◯, maintenance such as preliminary ejection is required at the time of restarting printing after the machine stop, but the evaluation criteria are at a possible level in actual operation. When the result is Δ, a printing appearance defect occurs or a maintenance frequency increases, and the productivity is poor in actual operation, which is undesirable. When the result is x, it is difficult to use for actual operation.

(Evaluation Criteria)

◯=In the ink set, the flying state of the ink droplets is good for all the inks. Even in a case where a non-ejection nozzle occurs at the time of restarting printing after 10 minutes from a stop with some inks, the non-ejection nozzle is eliminated by performing preliminary ejection of 100 shots.

Δ=In the ink set, the flying state of the ink droplets is unstable with some inks, or the non-ejection nozzle occurs at the time of restarting printing after 10 minutes from the stop, and the non-ejection nozzle is not eliminated even when the preliminary ejection of 100 shots is performed.

x=In the ink set, the flying state of the ink droplets is unstable with all of the inks, and the non-ejection nozzle occurs at the time of restarting printing after 10 minutes from the stop, and the non-ejection nozzle is not eliminated even when the preliminary ejection of 100 shots is performed.

<Evaluation of Visibility and Color Developability>

An inkjet printer equipped with an inkjet head (KM1024-LHB) manufactured by Konica Minolta, Inc. was used and filled with each ink. Thereafter, an identification number N3 fruit basket of an image described in 5. Representation method and definition of data in JIS X 9201:2001 was printed on a white background portion and a black background portion on a hiding power test paper (JIS standard product), curing was performed using a metal halide lamp, and then visibility and color developability of the printed material were visually evaluated. The results are shown in Tables 6 to 10.

When the result is ⊙, the texture is expressed up to the details of the fruit basket on both the white background portion and the black background portion of the hiding power test paper, and the color is vivid. When the result is ◯, although not as much as in the case of ⊙, there is visibility and vividness that can be recognized as a fruit basket on both the white background portion and the black background portion of the hiding power test paper. When the result is Δ, the appearances of the image printed on the white background portion and the black background portion of the hiding power test paper are different, and in particular, on the black background portion, a boundary line on the image is ambiguous and a color also looks dull. When the result is x, the colors of the images printed on the white background portion and the black background portion of the hiding power test paper are completely different, and the images cannot be recognized as a fruit basket on the black background portion.

(Evaluation Criteria)

⊙=There is no difference in color developability and visibility between the white background portion and the black background portion.

◯=Although the color developability is poor on the black background portion as compared with the white background portion, the image can be sufficiently recognized.

Δ=A boundary line of the image is more difficult to recognize on the black background portion than on the white background portion, resulting in a dull color.

x=The image cannot be reproduced on the black background portion.

### Total Evaluation of Experimental Examples 1 to 26

Experimental Examples 1 to 4, 6, 8, 10 to 14, 18, and 19 are ink sets that satisfy a well balance between the color reproducibility of the mixed color, mixed color gradation characteristics, ink ejection performance, visibility, and color developability. Experimental Examples 5, 7, 9, and 15 to 17 have excellent visibility and color developability, but have slightly poor ink ejection performance.

TABLE 6

| | | Experimental | Experimental | Experimental | Experimental | Experimental |
|---|---|---|---|---|---|---|
| | | Example 1 | Example 2 | Example 3 | Example 4 | Example 5 |
| | | C2 | C3 | C4 | C5 | C6 |
| | | Y2 | Y3 | Y4 | Y5 | Y6 |
| Ink set | | M2 | M3 | M4 | M5 | M6 |
| “1” Difference between actual measurement | 80:10:10 | 15 | 20 | 11 | 7 | 9 |
| value and theoretical value of hue angle in | 10:80:10 | 16 | 18 | 12 | 8 | 9 |
| each printing density ratio (*1) of CMY = x | 10:10:80 | 18 | 16 | 11 | 7 | 10 |
| (*1) Printing density ratio (C:M:Y) = | | | | | | |
| 80:10:10, 10:80:10, 10:10:80 | | | | | | |
| “2” Maximum change amount of hue angle | C:M | 13 | 14 | 10 | 7 | 14 |
| [symbol] H° in each combination and each printing | M:Y | 14 | 13 | 11 | 8 | 13 |
| density ratio (*2) of C:M, M:Y, and Y:C = y | Y:C | 13 | 14 | 9 | 7 | 12 |
| (*2) Printing density ratio (C:M, M:Y, | | | | | | |
| Y:C) = 100:100, 75:75, 50:50, 25:25 | | | | | | |
| “3” Difference between L* value of printed | C:M | 13 | 15 | 10 | 8 | 13 |
| material prepared with each combination of | M:Y | 12 | 13 | 9 | 7 | 12 |
| C:M, M:Y, and Y:C at each printing density | Y:C | 11 | 13 | 9 | 8 | 13 |
| ratio (*3) and L* value derived from | | | | | | |
| Expression (13) using L* value in white | | | | | | |
| background portion on black and white | | | | | | |
| hiding power paper = z | | | | | | |
| (*3) Printing density ratio (C:M, M:Y, | | | | | | |
| Y:C) = 50:50, 25:25 | | | | | | |
| Hue angle [symbol] H° of dried film formed using | C:M | 45 | 294 | 38 | 15 | 23 |
| each combination of C:M, M:Y, and Y:C | M:Y | 50 | 39 | 48 | 45 | 50 |
| and mixed color at volume ratio of 1:1 | Y:C | 116 | 163 | 124 | 138 | 140 |

| | | | | | |
|---|---|---|---|---|---|
| Difference in contrast ratio (maximum value) | 13 | 8 | 17 | 9 | 14 |
| Evaluation 1 of color reproducibility of mixed color | ◯ | ◯ | ◯ | ⊙ | ⊙ |
| Evaluation of mixed color gradation 1 | ◯ | ◯ | ◯ | ◯ | ◯ |
| Evaluation of mixed color gradation 2 | ◯ | ◯ | ◯ | ◯ | ◯ |
| Ink ejection performance | ◯ | ◯ | ◯ | ◯ | Δ |
| Visibility and color developability | ◯ | ◯ | ◯ | ⊙ | ⊙ |

TABLE 7

| | | Experimental | Experimental | Experimental | Experimental | Experimental |
|---|---|---|---|---|---|---|
| | | Example 6 | Example 7 | Example 8 | Example 9 | Example 10 |
| | | C7 | C6 | C5 | C4 | C4 |
| | | Y7 | Y4 | Y4 | Y6 | Y5 |
| Ink set | | M7 | M4 | M4 | M4 | M4 |
| “1” Difference between actual measurement | 80:10:10 | 4 | 8 | 7 | 8 | 9 |
| value and theoretical value of hue angle in | 10:80:10 | 5 | 9 | 8 | 9 | 8 |
| each printing density ratio (*1) of CMY = x | 10:10:80 | 4 | 10 | 8 | 8 | 8 |
| (*1) Printing density ratio (C:M:Y) = | | | | | | |
| 80:10:10, 10:80:10, 10:10:80 | | | | | | |
| “2” Maximum change amount of hue angle | C:M | 4 | 7 | 7 | 10 | 10 |
| [symbol] H° in each combination and each printing | M:Y | 5 | 8 | 11 | 10 | 9 |
| density ratio (*2) of C:M, M:Y, and Y:C = y | Y:C | 4 | 7 | 6 | 8 | 7 |
| (*2) Printing density ratio (C:M, M:Y, | | | | | | |
| Y:C) = 100:100, 75:75, 50:50, 25:25 | | | | | | |
| “3” Difference between L* value of printed | C:M | 5 | 8 | 8 | 10 | 10 |
| material prepared with each combination of | M:Y | 4 | 7 | 9 | 8 | 8 |
| C:M, M:Y, and Y:C at each printing density | Y:C | 5 | 8 | 7 | 8 | 6 |
| ratio (*3) and L* value derived from | | | | | | |
| Expression (13) using L* value in white | | | | | | |
| background portion on black and white | | | | | | |
| hiding power paper = z | | | | | | |
| (*3) Printing density ratio (C:M, M:Y, | | | | | | |
| Y:C) = 50:50, 25:25 | | | | | | |
| Hue angle [symbol] H° of dried film formed using | C:M | 16 | 20 | 22 | 38 | 38 |
| each combination of C:M, M:Y, and Y:C | M:Y | 44 | 48 | 48 | 51 | 47 |
| and mixed color at volume ratio of 1:1 | Y:C | 134 | 143 | 131 | 121 | 119 |

| | | | | | |
|---|---|---|---|---|---|
| Difference in contrast ratio (maximum value) | 1 | 11 | 15 | 17 | 24 |
| Evaluation 1 of color reproducibility of mixed color | ⊙ | ⊙ | ⊙ | ⊙ | ⊙ |
| Evaluation of mixed color gradation 1 | ◯ | ◯ | ◯ | ◯ | ◯ |
| Evaluation of mixed color gradation 2 | ◯ | ◯ | ◯ | ◯ | ◯ |
| Ink ejection performance | ◯ | Δ | ◯ | Δ | ◯ |
| Visibility and color developability | ⊙ | ◯ | ◯ | ◯ | ◯ |

TABLE 8

| | | Experimental | Experimental | Experimental | Experimental | Experimental |
|---|---|---|---|---|---|---|
| | | Example 11 | Example 12 | Example 13 | Example 14 | Example 15 |
| | | C5 | C7 | C5 | C7 | C7 |
| | | Y5 | Y5 | Y7 | Y7 | Y7 |
| Ink set | | M4 | M4 | M4 | M5 | M8 |
| “1” Difference between actual measurement | 80:10:10 | 6 | 5 | 5 | 5 | 10 |
| value and theoretical value of hue angle in | 10:80:10 | 8 | 8 | 8 | 7 | 9 |
| each printing density ratio (*1) of CMY = x | 10:10:80 | 8 | 8 | 5 | 5 | 9 |
| (*1) Printing density ratio (C:M:Y) = | | | | | | |
| 80:10:10, 10:80:10, 10:10:80 | | | | | | |
| “2” Maximum change amount of hue angle | C:M | 9 | 7 | 9 | 6 | 9 |
| [symbol] H° in each combination and each printing | M:Y | 9 | 9 | 7 | 7 | 9 |
| density ratio (*2) of C:M, M:Y, and Y:C = y | Y:C | 7 | 6 | 5 | 4 | 4 |
| (*2) Printing density ratio (C:M, M:Y, | | | | | | |
| Y:C) = 100:100, 75:75, 50:50, 25:25 | | | | | | |
| “3” Difference between L* value of printed | C:M | 9 | 6 | 9 | 6 | 9 |
| material prepared with each combination of | M:Y | 8 | 8 | 7 | 6 | 10 |
| C:M, M:Y, and Y:C at each printing density | Y:C | 8 | 7 | 6 | 5 | 5 |
| ratio (*3) and L* value derived from | | | | | | |
| Expression (13) using L* value in white | | | | | | |
| background portion on black and white | | | | | | |
| hiding power paper = z | | | | | | |
| (*3) Printing density ratio (C:M, M:Y, | | | | | | |
| Y:C) = 50:50, 25:25 | | | | | | |
| Hue angle [symbol] H° of dried film formed using | C:M | 22 | 14 | 22 | 16 | 27 |
| each combination of C:M, M:Y, and Y:C | M:Y | 47 | 47 | 49 | 42 | 38 |
| and mixed color at volume ratio of 1:1 | Y:C | 134 | 133 | 140 | 134 | 134 |

| | | | | | |
|---|---|---|---|---|---|
| Difference in contrast ratio (maximum value) | 7 | 7 | 8 | 6 | 25 |
| Evaluation 1 of color reproducibility of mixed color | ⊙ | ⊙ | ⊙ | ⊙ | ⊙ |
| Evaluation of mixed color gradation 1 | ◯ | ◯ | ◯ | ◯ | ◯ |
| Evaluation of mixed color gradation 2 | ◯ | ◯ | ◯ | ◯ | ◯ |
| Ink ejection performance | ◯ | ◯ | ◯ | ◯ | Δ |
| Visibility and color developability | ⊙ | ⊙ | ⊙ | ⊙ | ⊙ |

TABLE 9

| | | Experimental | Experimental | Experimental | Experimental | Experimental |
|---|---|---|---|---|---|---|
| | | Example 16 | Example 17 | Example 18 | Example 19 | Example 20 |
| | | C8 | C7 | C7 | C7 | C1 |
| | | Y7 | Y8 | Y7 | Y7 | Y1 |
| Ink set | | M7 | M7 | M9 | M10 | M1 |
| “1” Difference between actual measurement | 80:10:10 | 10 | 9 | 6 | 8 | 20 |
| value and theoretical value of hue angle in | 10:80:10 | 7 | 7 | 8 | 10 | 22 |
| each printing density ratio (*1) of CMY = x | 10:10:80 | 7 | 10 | 6 | 7 | 21 |
| (*1) Printing density ratio (C:M:Y) = | | | | | | |
| 80:10:10, 10:80:10, 10:10:80 | | | | | | |
| “2” Maximum change amount of hue angle | C:M | 10 | 4 | 8 | 10 | 16 |
| [symbol] H° in each combination and each printing | M:Y | 5 | 9 | 8 | 10 | 13 |
| density ratio (*2) of C:M, M:Y, and Y:C = y | Y:C | 8 | 8 | 4 | 4 | 16 |
| (*2) Printing density ratio (C:M, M:Y, | | | | | | |
| Y:C) = 100:100, 75:75, 50:50, 25:25 | | | | | | |
| “3” Difference between L* value of printed | C:M | 10 | 5 | 8 | 10 | 10 |
| material prepared with each combination of | M:Y | 4 | 9 | 7 | 9 | 9 |
| C:M, M:Y, and Y:C at each printing density | Y:C | 9 | 8 | 5 | 5 | 10 |
| ratio (*3) and L* value derived from | | | | | | |
| Expression (13) using L* value in white | | | | | | |
| background portion on black and white | | | | | | |
| hiding power paper = z | | | | | | |
| (*3) Printing density ratio (C:M, M:Y, | | | | | | |
| Y:C) = 50:50, 25:25 | | | | | | |
| Hue angle [symbol] H° of dried film formed using | C:M | 13 | 16 | 18 | 14 | 51 |
| each combination of C:M, M:Y, and Y:C | M:Y | 44 | 52 | 42 | 46 | 47 |
| and mixed color at volume ratio of 1:1 | Y:C | 142 | 120 | 134 | 134 | 112 |

| | | | | | |
|---|---|---|---|---|---|
| Difference in contrast ratio (maximum value) | 24 | 25 | 1 | 2 | 3 |
| Evaluation 1 of color reproducibility of mixed color | ⊙ | ⊙ | ⊙ | ⊙ | Δ |
| Evaluation of mixed color gradation 1 | ◯ | ◯ | ◯ | ◯ | Δ |
| Evaluation of mixed color gradation 2 | ◯ | ◯ | ◯ | ◯ | ◯ |
| Ink ejection performance | Δ | Δ | ◯ | ◯ | ◯ |
| Visibility and color developability | ⊙ | ⊙ | ◯ | ◯ | X |

TABLE 10

| | | Experimental | Experimental | Experimental | Experimental | Experimental | Experimental |
|---|---|---|---|---|---|---|---|
| | | Example 21 | Example 22 | Example 23 | Example 24 | Example 25 | Example 26 |
| | | C1 | C1 | C2 | C5 | C2 | C5 |
| | | Y2 | Y1 | Y1 | Y2 | Y5 | Y5 |
| Ink set | | M1 | M2 | M1 | M4 | M5 | M2 |
| “1” Difference between actual measurement | 80:10:10 | 21 | 22 | 17 | 12 | 38 | 12 |
| value and theoretical value of hue angle in | 10:80:10 | 21 | 16 | 22 | 11 | 37 | 31 |
| each printing density ratio (*1) of CMY = x | 10:10:80 | 17 | 21 | 21 | 31 | 35 | 14 |
| (*1) Printing density ratio (C:M:Y) = | | | | | | | |
| 80:10:10, 10:80:10, 10:10:80 | | | | | | | |
| “2” Maximum change amount of hue angle | C:M | 16 | 19 | 18 | 9 | 27 | 28 |
| [symbol] H° in each combination and each printing | M:Y | 18 | 19 | 13 | 26 | 8 | 27 |
| density ratio (*2) of C:M, M:Y, and Y:C = y | Y:C | 19 | 16 | 19 | 28 | 26 | 7 |
| (*2) Printing density ratio (C:M, M:Y, | | | | | | | |
| Y:C) = 100:100, 75:75, 50:50, 25:25 | | | | | | | |
| “3” Difference between L* value of printed | C:M | 10 | 16 | 17 | 9 | 31 | 27 |
| material prepared with each combination of | M:Y | 16 | 17 | 9 | 21 | 7 | 26 |
| C:M, M:Y, and Y:C at each printing density | Y:C | 15 | 10 | 16 | 22 | 30 | 8 |
| ratio (*3) and L* value derived from | | | | | | | |
| Expression (13) using L* value in white | | | | | | | |
| background portion on black and white | | | | | | | |
| hiding power paper = z | | | | | | | |
| (*3) Printing density ratio (C:M, M:Y, | | | | | | | |
| Y:C) = 50:50, 25:25 | | | | | | | |
| Hue angle [symbol] H° of dried film formed using | C:M | 51 | 53 | 44 | 15 | 15 | 35 |
| each combination of C:M, M:Y, and Y:C | M:Y | 62 | 46 | 47 | 40 | 45 | 60 |
| and mixed color at volume ratio of 1:1 | Y:C | 108 | 108 | 120 | 137 | 138 | 138 |

| | | | | | | |
|---|---|---|---|---|---|---|
| Difference in contrast ratio (maximum value) | 21 | 25 | 10 | 27 | 45 | 26 |
| Evaluation 1 of color reproducibility of mixed color | Δ | Δ | Δ | X | X | X |
| Evaluation of mixed color gradation 1 | Δ | Δ | Δ | X | X | X |
| Evaluation of mixed color gradation 2 | Δ | Δ | Δ | Δ | X | X |
| Ink ejection performance | ◯ | ◯ | ◯ | ◯ | ◯ | ◯ |
| Visibility and color developability | X | X | X | Δ | Δ | Δ |

### Examples 1 to 37 and Comparative Examples 1 to 7

Next, the following evaluations were performed using the ink sets (Examples 1 to 37 and Comparative Examples 1 to 7) of combinations shown in Tables 11 to 19 and the coating materials A to E for an ink receiving layer.

Hereinafter, a production method of an ink receiving layer, a preparation method of a printed material for evaluation, an average dot diameter, an L* value, color reproducibility of a mixed color, an evaluation method of visibility and color developability of a printed material, and evaluation criteria will be described.

<Production Method of Ink Receiving Layers A to E>

An aqueous sealer (manufactured by Dai Nippon Toryo Co., Ltd., product name: Aqueous MIGHTY SEALER MULTI) was applied onto the surface of a slate plate (150 mm×70 mm×5 mm, manufactured by TP Giken Co., Ltd.) with an air spray in an application amount of 100 g/m², and drying was performed at room temperature for 2 hours, thereby producing a sealer coated substrate. Each of the coating materials A to E for an ink receiving layer was applied onto the sealer coated surface of the substrate with an air spray so that the application amount was 120 g/m² in a state where the sealer coated substrate was heated to 60° C. Thereafter, drying was performed in a drying furnace set at 100° C. for 3 minutes to prepare substrates comprising the ink receiving layers A to E.

<Preparation Method 2 of Printed Material for Evaluation>

Using an inkjet printer equipped with an inkjet head (KM1024-LHB) manufactured by Konica Minolta, Inc., a single color solid image was adjusted at a printing density ratio (volume ratio) of 50:50:50 for CMY under a condition of a resolution of 360×360 dpi and a printing density ratio (volume ratio) of 100:100 for two colors among the respective combinations of CMY, and printing was performed by superimposing the adjusted images on a white background portion on a hiding power test paper (JIS standard product) and the substrate or the ink receiving layer shown in Tables 11 to 19. After the printing, the setting time shown in Tables 11 to 19 was set, and after the elapse of the setting time, curing was performed using a metal halide lamp to obtain an ink dried film (decorative layer). Thus, a printed material for evaluating the L* value and the color reproducibility of the mixed color was prepared.

The printed material for evaluation of an average dot diameter was prepared by adjusting a single color solid image of each single color of CMY at a printing density of 3%, printing the adjusted image on the substrate or the ink receiving layer shown in Tables 11 to 19, setting the setting time shown in Tables 11 to 19, and curing the image using a metal halide lamp after the setting time passed.

Note that, in the evaluation of the L* value and the color reproducibility of the mixed color, the decorative layer on the white background portion of the hiding power test paper and the decorative layer on the substrate or the ink receiving layer were compared and evaluated. Therefore, the setting time after printing was adjusted on the white background portion of the hiding power test paper so that the average dot diameter on the white background portion of the hiding power test paper was equivalent to the average dot diameter on the substrate or the ink receiving layer. The average dot diameter was calculated by observing an image magnified 200 times with a microscope (manufactured by Keyence Corporation).

The annotations attached to the substrates in Tables 11 to 19 are as follows.

c) Polyvinyl chloride gray (manufactured by TP Giken Co., Ltd.)

<Average Dot Diameter>

For the printed material prepared according to <Preparation Method 2 of Printed Material for Evaluation>, the average dot diameter was determined from a photographic image obtained by magnifying the cyan ink, the magenta ink, and the yellow ink printed on the substrate or the ink receiving layer 200 times using a microscope (VHX-S550, manufactured by Keyence Corporation). The results are shown in Tables 11 to 19. A unit of the average dot diameter shown in the tables is μm.

<L* Value>

The L* value of the surface on which the decorative layer is to be formed in <Preparation Method 2 of Printed Material for Evaluation> (that is, the substrate or the ink receiving layer formed on the substrate) was measured. In addition, the L* value of the decorative layer formed on the substrate or the ink receiving layer was measured using the printed material prepared in <Preparation Method 2 of Printed Material for Evaluation>. The L* value was measured using a spectrophotometer (for example, eXact, manufactured by X-Rite, Inc.). The results are shown in Tables 11 to 19.

In Tables 11 to 19, the L* value of the decorative layer shown in the item “C:M:Y” is an L* value of the decorative layer printed with the cyan ink, the magenta ink, and the yellow ink at a printing density ratio (volume ratio) of 50:50:50, the L* value of the decorative layer shown in the item “C:M” is an L* value of the decorative layer printed with the cyan ink and the magenta ink at a printing density ratio (volume ratio) of 100:100, the L* value of the decorative layer shown in the item “M:Y” is an L* value of the decorative layer printed with the magenta ink and the yellow ink at a printing density ratio (volume ratio) of 100:100, and the L* value of the decorative layer shown in the item “Y:C” is an L* value of the decorative layer printed with the yellow ink and the cyan ink at a printing density ratio (volume ratio) of 100:100.

<Evaluation Method 2 of Color Reproducibility of Mixed Color>

The hue angle, the a* value, and the b* value of the decorative layer prepared according to <Preparation Method 2 of Printed Material for Evaluation> were measured. For each color combination, the gradation characteristics of the mixed color was evaluated from the difference in hue angle (w described below) between the decorative layer prepared on the white background portion of the hiding power test paper and the decorative layer prepared on the substrate or the ink receiving layer. In addition, a color density of the mixed color was evaluated from the color difference between the a* value and the b* value (ΔC_{ab} described below). The results are shown in Tables 11 to 19. When both w and ΔC_{ab} showed a result of ⊙ or ◯ in the evaluation criteria in each evaluation described below, it was determined that the color reproducibility of the mixed color was excellent.

W can be calculated by Expression (3) from the hue angle measured using a spectrophotometer (eXact, manufactured by X-Rite, Inc.) for the decorative layer prepared according to <Preparation Method 2 of Printed Material for Evaluation>.

w=∠H°_{A}−∠H°_{B} Expression (3)

∠H°_{A} in Expression (3) represents the hue angle of the decorative layer prepared on the white background portion of the hiding power test paper, and ∠H°_{B} represents the hue angle of the decorative layer prepared on the substrate or the ink receiving layer.

In the tables, “w” described in the item “C:M:Y” is a value calculated from the hue angle of the decorative layer in which the cyan ink, the magenta ink, and the yellow ink are printed at a printing density ratio (volume ratio) of 50:50:50, “w” described in the item “C:M” is a value calculated from the hue angle of the decorative layer in which the cyan ink and the magenta ink are printed at a printing density ratio (volume ratio) of 100:100, “w” described in the item “M:Y” is a value calculated from the hue angle of the decorative layer in which the magenta ink and the yellow ink are printed at a printing density ratio (volume ratio) of 100:100, and “w” described in the item “Y:C” is a value calculated from the hue angle of the decorative layer in which the yellow ink and the cyan ink are printed at a printing density ratio (volume ratio) of 100:100.

ΔC_{ab} can be calculated by Expression (4) from the a* value and the b* value measured using a spectrophotometer (eXact, manufactured by X-Rite, Inc.) for the decorative layer prepared according to <Preparation Method 2 of Printed Material for Evaluation>.

ΔC_{ab}=((a₁−b₁)²−(a₂+b₂)²)^{1/2} Expression (4)

In Expression (4), a₁ represents an a* value of the decorative layer prepared on the white background portion of the hiding power test paper, b₁ represents a b* value of the decorative layer prepared on the white background portion of the hiding power test paper, a₂ represents an a* value of the decorative layer prepared on each substrate, and b₂ represents a b* value of the decorative layer prepared on each substrate.

In the tables, “ΔC_{ab}” described in the item “C:M:Y” is a value calculated from the a* value and the b* value of the decorative layer in which the cyan ink, the magenta ink, and the yellow ink are printed at a printing density ratio (volume ratio) of 50:50:50, “ΔC_{ab}” described in the item “C:M” is a value calculated from the a* value and the b* value of the decorative layer in which the cyan ink and the magenta ink are printed at a printing density ratio (volume ratio) of 100:100, “ΔC_{ab}” described in the item “M:Y” is a value calculated from the a* value and the b* value of the decorative layer in which the magenta ink and the yellow ink are printed at a printing density ratio (volume ratio) of 100:100, and “ΔC_{ab}” described in the item “Y:C” is a value calculated from the a* value and the b* value of the decorative layer in which the yellow ink and the cyan ink are printed at a printing density ratio (volume ratio) of 100:100.

<Evaluation 2 of Color Reproducibility of Mixed Color>Gradation Characteristics of Mixed Color

For the decorative layer prepared according to <Preparation Method 2 of Printed Material for Evaluation>, w was calculated by the method described in <Evaluation Method 2 of Color Reproducibility of Mixed Color>, and the gradation characteristics of the mixed color was evaluated based on the following evaluation criteria. The results are shown in Tables 11 to 19.

(Evaluation Criteria)

⊙=The w values calculated for the respective mixed color printed materials all satisfy 0≤w≤10.

◯=The w values calculated for the respective mixed color printed materials all satisfy w≤15, and at least some w values satisfy 10<w≤15.

Δ=The w values calculated for the respective mixed color printed materials all satisfy w≤25, and at least some w values satisfy 15<w≤25.

x=Some or all the w values calculated for the respective mixed color printed materials satisfy w>25.

When the result is ⊙, the color tone at the time of color mixing is hardly affected by the L* value of the substrate or the ink receiving layer, and a wide variety of colors can be expressed. When the result is ◯, although not as much as ⊙, the influence of the L* value of the substrate or the ink receiving layer is small, and the gradation characteristics of the mixed color is excellent. When the result is Δ, it can be seen that the gradation characteristics of the mixed color decreases. When the result is x, it can be said that there is almost no gradation characteristics at the time of color mixing.

<Evaluation 3 of Color Reproducibility of Mixed Color> Color Density of Mixed Color

For the decorative layer prepared according to <Preparation Method 2 of Printed Material for Evaluation>, ΔC_{ab} was calculated by the method described in <Evaluation Method 2 of Color Reproducibility of Mixed Color>, and the color density of the mixed color was evaluated based on the following evaluation criteria. The results are shown in Tables 11 to 19.

(Evaluation Criteria)

⊙=The ΔC_{ab} values calculated for the respective mixed color printed materials all satisfy 0≤ΔC_{ab}≤10.

◯=The ΔC_{ab} values calculated for the respective mixed color printed materials all satisfy ΔC_{ab}≤20, and at least some ΔC_{ab} values satisfy 10<ΔC_{ab}≤20.

Δ=The ΔC_{ab} values calculated for the respective mixed color printed materials all satisfy ΔC_{ab}≤30, and at least some ΔC_{ab} values satisfy 20<ΔC_{ab}≤30.

x=Some or all the ΔC_{ab} values calculated for the respective mixed color printed materials satisfy ΔC_{ab}>30.

When the result is ⊙, the color development is hardly affected by the L* value of the substrate or the ink receiving layer, and the color reproducibility of the mixed color is excellent. When the result is ◯, although not as much as ⊙, the influence of the L* value of the substrate or the ink receiving layer is small, and a mixed color having excellent visibility can be reproduced. When the result is Δ, the color is dull, and the color reproducibility is also deteriorated as well as the color developability of the mixed color is deteriorated. When the result is x, color dullness is large, and the color reproducibility of the mixed color is lost.

<Evaluation of Visibility and Color Developability>

An inkjet printer equipped with an inkjet head (KM1024-LHB) manufactured by Konica Minolta, Inc. was used and filled with each ink. Thereafter, an identification number N3 fruit basket of an image described in 5. Representation method and definition of data in JIS X 9201:2001 was printed on the substrate or the ink receiving layer shown in Tables 11 to 19, the setting time shown in Tables 11 to 19 was provided, and after the setting time has elapsed, curing was performed using a metal halide lamp. The visibility and color developability of the printed material were visually evaluated based on the following evaluation criteria. The results are shown in Tables 11 to 19.

(Evaluation Criteria)

⊙=Excellent reproduction of both texture and color vividness over the details of a fruit basket can be achieved.

◯=The boundary line on the image of the fruit basket is clear and excellent in color vividness.

Δ=The boundary line on the image of the fruit basket appears blurred in some parts, or the vividness of the color is reduced in some parts.

x=Dullness of the color of the entire image is large, or the boundary line is unclear.

When the result is ⊙, the texture is expressed even in the details of the fruit basket and the color is vivid, which indicates that the coated body is suitable for image expression with high sharpness such as a red brick pattern. When the result is ◯, although not as clear as ⊙, a vivid image is obtained, and the boundary line is also clear, such that image expression with high sharpness is also sufficiently possible. When the result is Δ, although a printed material in which the color of each fruit is reproduced is obtained as an image of a fruit basket, there are a portion where the boundary line is ambiguous and a portion where the color is poor in vividness. When the result is x, the color dullness is large, and the original color of the fruit or the basket cannot be expressed, or the boundary line or the image is unclear, and thus it is inappropriate as a printed material.

<Contrast Ratio>

Based on the measurement results of the contrast ratios in Experimental Examples 1 to 26, the value of the contrast ratio of each ink and the difference in the contrast ratio between the inks constituting the ink set are shown in Tables 11 to 19.

### Total Evaluation of Examples

Examples 1 to 37 are coated bodies that are excellent in the gradation characteristics of the mixed color, the color density of the mixed color, the visibility, and the color developability and can express an image with high sharpness.

TABLE 11

| | | Example 1 | Example 2 | Example 3 | Example 4 | Example 5 |
|---|---|---|---|---|---|---|
| Ink set | | C2 | C3 | C4 | C5 | C6 |
| | | Y2 | Y3 | Y4 | Y5 | Y6 |
| | | M2 | M3 | M4 | M5 | M6 |
| Substrate | | Rigid | Rigid | Rigid | Rigid | Rigid |
| | | polyvinyl | polyvinyl | polyvinyl | polyvinyl | polyvinyl |
| | | chloride^{a)} | chloride^{a)} | chloride^{a)} | chloride^{a)} | chloride^{a)} |
| Ink receiving layer | | — | — | — | — | — |
| Setting time (sec) | | 3 | 3 | 3 | 3 | 3 |
| Average dot diameter | | 65 | 65 | 65 | 68 | 65 |
| L* value of substrate | | 60 | 60 | 60 | 60 | 60 |
| L* value of ink receiving layer | | — | — | — | — | — |
| L* value of decorative layer | C:M:Y | 49 | 44 | 46 | 53 | 49 |
| | C:M | 43 | 44 | 47 | 52 | 49 |
| | M:Y | 49 | 45 | 47 | 52 | 49 |
| | Y:C | 50 | 47 | 46 | 51 | 48 |
| Evaluation 2 of color | C:M:Y | 15 | 13 | 13 | 9 | 10 |
| reproducibility of mixed color | C:M | 14 | 13 | 13 | 8 | 9 |
| Difference in hue angle [symbol] H° | M:Y | 15 | 15 | 14 | 9 | 10 |
| of mixed color printed | Y:C | 15 | 14 | 14 | 9 | 10 |
| material = w | | | | | | |
| Evaluation 3 of color | C:M:Y | 18 | 19 | 17 | 13 | 15 |
| reproducibility of mixed color | C:M | 17 | 16 | 16 | 12 | 14 |
| Color difference between a | M:Y | 18 | 17 | 17 | 13 | 14 |
| value and b value of mixed | Y:C | 19 | 18 | 17 | 14 | 15 |
| color printed material = ΔC_{ab} | | | | | | |
| Contrast ratio (%) | Ch | 17 | 25 | 32 | 53 | 48 |
| | Yh | 26 | 33 | 38 | 56 | 45 |
| | Mh | 30 | 29 | 49 | 62 | 59 |
| Difference in contrast ratio | \|Ch − Mh\| | 13 | 4 | 17 | 9 | 11 |
| | \|Mh − Yh\| | 4 | 4 | 11 | 6 | 14 |
| | \|Yh − Ch\| | 9 | 8 | 6 | 3 | 3 |
| Evaluation results | Gradation of | ◯ | ◯ | ◯ | ⊙ | ⊙ |
| | mixed color | | | | | |
| | Color density | ◯ | ◯ | ◯ | ◯ | ◯ |
| | of mixed color | | | | | |
| | Visibility | ◯ | ◯ | ◯ | ⊙ | ◯ |
| | and color | | | | | |
| | developability | | | | | |

TABLE 12

| | | Example 6 | Example 7 | Example 8 | Example 9 | Example 10 |
|---|---|---|---|---|---|---|
| Ink set | | C7 | C2 | C2 | C2 | C2 |
| | | Y7 | Y2 | Y2 | Y2 | Y2 |
| | | M7 | M2 | M2 | M2 | M2 |
| Substrate | | Rigid | — | — | — | — |
| | | polyvinyl | | | | |
| | | chloride^{a)} | | | | |
| Ink receiving layer | | — | A | B | C | D |
| Setting time (sec) | | 3 | 3 | 3 | 3 | 3 |
| Average dot diameter | | 75 | 134 | 133 | 135 | 134 |
| L* value of substrate | | 60 | — | — | — | — |
| L* value of ink receiving layer | | — | 98 | 67 | 50 | 40 |
| L* value of decorative layer | C:M:Y | 55 | 71 | 60 | 54 | 43 |
| | C:M | 54 | 69 | 57 | 45 | 42 |
| | M:Y | 53 | 70 | 59 | 50 | 43 |
| | Y:C | 53 | 75 | 66 | 53 | 45 |
| Evaluation 2 of color | C:M:Y | 10 | 5 | 10 | 12 | 14 |
| reproducibility of mixed color | C:M | 9 | 6 | 9 | 12 | 14 |
| Difference in hue angle [symbol] H° | M:Y | 10 | 6 | 11 | 13 | 15 |
| of mixed color printed | Y:C | 10 | 6 | 11 | 13 | 15 |
| material = w | | | | | | |
| Evaluation 3 of color | C:M:Y | 11 | 5 | 12 | 13 | 17 |
| reproducibility of mixed color | C:M | 11 | 5 | 12 | 13 | 16 |
| Color difference between a | M:Y | 10 | 6 | 13 | 14 | 17 |
| value and b value of mixed | Y:C | 11 | 5 | 12 | 14 | 17 |
| color printed material = ΔC_{ab} | | | | | | |
| Contrast ratio (%) | Ch | 56 | 17 | 17 | 17 | 17 |
| | Yh | 57 | 26 | 26 | 26 | 26 |
| | Mh | 57 | 30 | 30 | 30 | 30 |
| Difference in contrast ratio | \|Ch − Mh\| | 1 | 13 | 13 | 13 | 13 |
| | \|Mh − Yh\| | 0 | 4 | 4 | 4 | 4 |
| | \|Yh − Ch\| | 1 | 9 | 9 | 9 | 9 |
| Evaluation results | Gradation of | ⊙ | ⊙ | ◯ | ◯ | ◯ |
| | mixed color | | | | | |
| | Color density | ◯ | ⊙ | ◯ | ◯ | ◯ |
| | of mixed color | | | | | |
| | Visibility | ⊙ | ◯ | ◯ | ◯ | ◯ |
| | and color | | | | | |
| | developability | | | | | |

TABLE 13

| | | Example | Example | Example | Example | Example |
|---|---|---|---|---|---|---|
| | | 11 | 12 | 13 | 14 | 15 |
| Ink set | | C2 | C3 | C3 | C3 | C3 |
| | | Y2 | Y3 | Y3 | Y3 | Y3 |
| | | M2 | M3 | M3 | M3 | M3 |
| Substrate | | — | — | — | — | — |
| Ink receiving layer | | E | A | B | C | D |
| Setting time (sec) | | 3 | 3 | 3 | 3 | 3 |
| Average dot diameter | | 144 | 134 | 133 | 135 | 134 |
| L* value of substrate | | — | — | — | — | — |
| L* value of ink receiving layer | | 50 | 98 | 67 | 50 | 40 |
| L* value of decorative layer | C:M:Y | 51 | 71 | 62 | 51 | 44 |
| | C:M | 49 | 69 | 53 | 48 | 43 |
| | M:Y | 52 | 71 | 60 | 52 | 41 |
| | Y:C | 54 | 77 | 65 | 51 | 45 |
| Evaluation 2 of color | C:M:Y | 10 | 5 | 10 | 13 | 15 |
| reproducibility of mixed color | C:M | 9 | 6 | 9 | 12 | 14 |
| Difference in hue angle [symbol] H° | M:Y | 10 | 5 | 12 | 12 | 16 |
| of mixed color printed | Y:C | 10 | 5 | 11 | 13 | 15 |
| material = w | | | | | | |
| Evaluation 3 of color | C:M:Y | 10 | 5 | 12 | 12 | 18 |
| reproducibility of mixed color | C:M | 10 | 6 | 13 | 13 | 17 |
| Color difference between a | M:Y | 10 | 5 | 13 | 14 | 18 |
| value and b value of mixed | Y:C | 10 | 6 | 12 | 13 | 18 |
| color printed material = ΔC_{ab} | | | | | | |
| Contrast ratio (%) | Ch | 17 | 25 | 25 | 25 | 25 |
| | Yh | 26 | 33 | 33 | 33 | 33 |
| | Mh | 30 | 29 | 29 | 29 | 29 |
| Difference in contrast ratio | \|Ch − Mh\| | 13 | 4 | 4 | 4 | 4 |
| | \|Mh − Yh\| | 4 | 4 | 4 | 4 | 4 |
| | \|Yh − Ch\| | 9 | 8 | 8 | 8 | 8 |
| Evaluation results | Gradation of | ⊙ | ⊙ | ◯ | ◯ | ◯ |
| | mixed color | | | | | |
| | Color density | ◯ | ⊙ | ◯ | ◯ | ◯ |
| | of mixed color | | | | | |
| | Visibility | ◯ | ◯ | ◯ | ◯ | ◯ |
| | and color | | | | | |
| | developability | | | | | |

TABLE 14

| | | Example | Example | Example | Example | Example |
|---|---|---|---|---|---|---|
| | | 16 | 17 | 18 | 19 | 20 |
| Ink set | | C3 | C4 | C4 | C4 | C4 |
| | | Y3 | Y4 | Y4 | Y4 | Y4 |
| | | M3 | M4 | M4 | M4 | M4 |
| Substrate | | — | — | — | — | — |
| Ink receiving layer | | E | A | B | C | D |
| Setting time (sec) | | 3 | 3 | 3 | 3 | 3 |
| Average dot diameter | | 144 | 134 | 133 | 135 | 134 |
| L* value of substrate | | — | — | — | — | — |
| L* value of ink receiving layer | | 50 | 98 | 67 | 50 | 40 |
| L* value of decorative layer | C:M:Y | 54 | 68 | 57 | 52 | 46 |
| | C:M | 48 | 64 | 54 | 52 | 45 |
| | M:Y | 55 | 67 | 56 | 53 | 44 |
| | Y:C | 54 | 70 | 63 | 53 | 48 |
| Evaluation 2 of color | C:M:Y | 10 | 4 | 10 | 12 | 14 |
| reproducibility of mixed color | C:M | 9 | 5 | 9 | 12 | 13 |
| Difference in hue angle [symbol] H° | M:Y | 10 | 5 | 10 | 12 | 14 |
| of mixed color printed | Y:C | 10 | 5 | 11 | 13 | 15 |
| material = w | | | | | | |
| Evaluation 3 of color | C:M:Y | 10 | 5 | 11 | 12 | 16 |
| reproducibility of mixed color | C:M | 10 | 4 | 11 | 13 | 14 |
| Color difference between a | M:Y | 10 | 5 | 12 | 13 | 16 |
| value and b value of mixed | Y:C | 10 | 4 | 12 | 13 | 15 |
| color printed material = ΔC_{ab} | | | | | | |
| Contrast ratio (%) | Ch | 25 | 32 | 32 | 32 | 32 |
| | Yh | 33 | 38 | 38 | 38 | 38 |
| | Mh | 29 | 49 | 49 | 49 | 49 |
| Difference in contrast ratio | \|Ch − Mh\| | 4 | 17 | 17 | 17 | 17 |
| | \|Mh − Yh\| | 4 | 11 | 11 | 11 | 11 |
| | \|Yh − Ch\| | 8 | 6 | 6 | 6 | 6 |
| Evaluation results | Gradation of | ⊙ | ⊙ | ◯ | ◯ | ◯ |
| | mixed color | | | | | |
| | Color density | ◯ | ⊙ | ◯ | ◯ | ◯ |
| | of mixed color | | | | | |
| | Visibility | ◯ | ◯ | ◯ | ◯ | ◯ |
| | and color | | | | | |
| | developability | | | | | |

TABLE 15

| | | Example | Example | Example | Example | Example |
|---|---|---|---|---|---|---|
| | | 21 | 22 | 23 | 24 | 25 |
| Ink set | | C4 | C6 | C5 | C4 | C4 |
| | | Y4 | Y4 | Y4 | Y6 | Y5 |
| | | M4 | M4 | M4 | M4 | M4 |
| Substrate | | — | Rigid | Rigid | Rigid | Rigid |
| | | | polyvinyl | polyvinyl | polyvinyl | polyvinyl |
| | | | chloride^{a)} | chloride^{a)} | chloride^{a)} | chloride^{a)} |
| Ink receiving layer | | E | — | — | — | — |
| Setting time (sec) | | 3 | 3 | 3 | 3 | 3 |
| Average dot diameter | | 144 | 65 | 65 | 65 | 65 |
| L* value of substrate | | — | 60 | 60 | 60 | 60 |
| L* value of ink receiving layer | | 50 | — | — | — | — |
| L* value of decorative layer | C:M:Y | 54 | 47 | 48 | 47 | 48 |
| | C:M | 54 | 50 | 51 | 47 | 47 |
| | M:Y | 53 | 47 | 47 | 48 | 49 |
| | Y:C | 57 | 49 | 47 | 47 | 48 |
| Evaluation 2 of color | C:M:Y | 10 | 11 | 12 | 12 | 11 |
| reproducibility of mixed color | C:M | 9 | 11 | 12 | 13 | 12 |
| Difference in hue angle [symbol] H° | M:Y | 9 | 14 | 14 | 13 | 12 |
| of mixed color printed | Y:C | 10 | 12 | 13 | 13 | 12 |
| material = w | | | | | | |
| Evaluation 3 of color | C:M:Y | 10 | 14 | 16 | 16 | 15 |
| reproducibility of mixed color | C:M | 9 | 13 | 15 | 16 | 15 |
| Color difference between a | M:Y | 9 | 17 | 17 | 14 | 13 |
| value and b value of mixed | Y:C | 10 | 14 | 16 | 15 | 14 |
| color printed material = ΔC_{ab} | | | | | | |
| Contrast ratio (%) | Ch | 32 | 48 | 53 | 32 | 32 |
| | Yh | 38 | 38 | 38 | 45 | 56 |
| | Mh | 49 | 49 | 49 | 49 | 49 |
| Difference in contrast ratio | \|Ch − Mh\| | 17 | 1 | 4 | 17 | 17 |
| | \|Mh − Yh\| | 11 | 11 | 11 | 4 | 7 |
| | \|Yh − Ch\| | 6 | 10 | 15 | 13 | 24 |
| Evaluation results | Gradation of | ⊙ | ◯ | ◯ | ◯ | ◯ |
| | mixed color | | | | | |
| | Color density | ◯ | ◯ | ◯ | ◯ | ◯ |
| | of mixed color | | | | | |
| | Visibility | ◯ | ◯ | ◯ | ◯ | ◯ |
| | and color | | | | | |
| | developability | | | | | |

TABLE 16

| | | Example | Example | Example | Example | Example |
|---|---|---|---|---|---|---|
| | | 26 | 27 | 28 | 29 | 30 |
| Ink set | | C5 | C7 | C8 | C7 | C7 |
| | | Y5 | Y7 | Y7 | Y8 | Y7 |
| | | M4 | M8 | M5 | M5 | M9 |
| Substrate | | Rigid | Rigid | Rigid | Rigid | Rigid |
| | | polyvinyl | polyvinyl | polyvinyl | polyvinyl | polyvinyl |
| | | chloride^{a)} | chloride^{a)} | chloride^{a)} | chloride^{a)} | chloride^{a)} |
| Ink receiving layer | | — | — | — | — | — |
| Setting time (sec) | | 3 | 3 | 3 | 3 | 3 |
| Average dot diameter | | 65 | 65 | 69 | 68 | 71 |
| L* value of substrate | | 60 | 60 | 60 | 60 | 60 |
| L* value of ink receiving layer | | — | — | — | — | — |
| L* value of decorative layer | C:M:Y | 51 | 50 | 56 | 53 | 54 |
| | C:M | 50 | 51 | 56 | 51 | 52 |
| | M:Y | 51 | 50 | 51 | 51 | 51 |
| | Y:C | 51 | 53 | 56 | 52 | 53 |
| Evaluation 2 of color | C:M:Y | 10 | 11 | 14 | 14 | 13 |
| reproducibility of mixed color | C:M | 9 | 10 | 14 | 11 | 13 |
| Difference in hue angle [symbol] H° | M:Y | 10 | 11 | 13 | 14 | 12 |
| of mixed color printed | Y:C | 10 | 10 | 14 | 15 | 10 |
| material = w | | | | | | |
| Evaluation 3 of color | C:M:Y | 12 | 12 | 18 | 18 | 14 |
| reproducibility of mixed color | C:M | 11 | 12 | 19 | 12 | 12 |
| Color difference between a | M:Y | 12 | 11 | 12 | 18 | 13 |
| value and b value of mixed | Y:C | 13 | 12 | 17 | 18 | 11 |
| color printed material = ΔC_{ab} | | | | | | |
| Contrast ratio (%) | Ch | 53 | 56 | 81 | 56 | 56 |
| | Yh | 56 | 57 | 57 | 81 | 57 |
| | Mh | 49 | 81 | 62 | 62 | 56 |
| Difference in contrast ratio | \|Ch − Mh\| | 4 | 25 | 19 | 6 | 0 |
| | \|Mh − Yh\| | 7 | 24 | 5 | 19 | 1 |
| | \|Yh − Ch\| | 3 | 1 | 24 | 25 | 1 |
| Evaluation results | Gradation of | ⊙ | ◯ | ◯ | ◯ | ◯ |
| | mixed color | | | | | |
| | Color density | ◯ | ◯ | ◯ | ◯ | ◯ |
| | of mixed color | | | | | |
| | Visibility | ⊙ | ⊙ | ⊙ | ⊙ | Δ |
| | and color | | | | | |
| | developability | | | | | |

TABLE 17

| | | Example | Example | Example | Example | Example |
|---|---|---|---|---|---|---|
| | | 31 | 32 | 33 | 34 | 35 |
| Ink set | | C7 | C7 | C5 | C7 | C7 |
| | | Y7 | Y5 | Y7 | Y7 | Y7 |
| | | M10 | M4 | M4 | M5 | M5 |
| Substrate | | Rigid | Rigid | Rigid | Rigid | — |
| | | polyvinyl | polyvinyl | polyvinyl | polyvinyl | |
| | | chloride^{a)} | chloride^{a)} | chloride^{a)} | chloride^{a)} | |
| Ink receiving layer | | — | — | — | — | E |
| Setting time (sec) | | 3 | 3 | 3 | 3 | 3 |
| Average dot diameter | | 71 | 68 | 65 | 65 | 149 |
| L* value of substrate | | 60 | 60 | 60 | 60 | — |
| L* value of ink receiving layer | | — | — | — | — | 50 |
| L* value of decorative layer | C:M:Y | 51 | 51 | 51 | 52 | 57 |
| | C:M | 51 | 50 | 50 | 52 | 54 |
| | M:Y | 50 | 49 | 52 | 51 | 55 |
| | Y:C | 53 | 52 | 52 | 53 | 55 |
| Evaluation 2 of color | C:M:Y | 15 | 11 | 10 | 8 | 7 |
| reproducibility of mixed color | C:M | 15 | 11 | 9 | 8 | 7 |
| Difference in hue angle [symbol] H° | M:Y | 13 | 10 | 10 | 9 | 6 |
| of mixed color printed | Y:C | 10 | 8 | 10 | 9 | 7 |
| material = w | | | | | | |
| Evaluation 3 of color | C:M:Y | 15 | 12 | 11 | 10 | 6 |
| reproducibility of mixed color | C:M | 14 | 12 | 11 | 11 | 6 |
| Color difference between a | M:Y | 15 | 11 | 11 | 10 | 7 |
| value and b value of mixed | Y:C | 11 | 11 | 12 | 11 | 7 |
| color printed material = ΔC_{ab} | | | | | | |
| Contrast ratio (%) | Ch | 56 | 56 | 53 | 56 | 56 |
| | Yh | 57 | 56 | 57 | 57 | 57 |
| | Mh | 55 | 49 | 49 | 62 | 62 |
| Difference in contrast ratio | \|Ch − Mh\| | 1 | 7 | 4 | 6 | 6 |
| | \|Mh − Yh\| | 2 | 7 | 8 | 5 | 5 |
| | \|Yh − Ch\| | 1 | 0 | 4 | 1 | 1 |
| Evaluation results | Gradation of | ◯ | ◯ | ⊙ | ⊙ | ⊙ |
| | mixed color | | | | | |
| | Color density | ◯ | ◯ | ◯ | ◯ | ⊙ |
| | of mixed color | | | | | |
| | Visibility | Δ | ◯ | ◯ | ◯ | ⊙ |
| | and color | | | | | |
| | developability | | | | | |

TABLE 18

| | | Example | Example | Comparative | Comparative | Comparative |
|---|---|---|---|---|---|---|
| | | 36 | 37 | Example 1 | Example 2 | Example 3 |
| Ink set | | C7 | C7 | C1 | C1 | C1 |
| | | Y7 | Y7 | Y1 | Y2 | Y1 |
| | | M6 | M7 | M1 | M1 | M2 |
| Substrate | | — | — | Rigid | Rigid | Rigid |
| | | | | polyvinyl | polyvinyl | polyvinyl |
| | | | | chloride^{a)} | chloride^{a)} | chloride^{a)} |
| Ink receiving layer | | E | E | — | — | — |
| Setting time (sec) | | 3 | 3 | 3 | 3 | 3 |
| Average dot diameter | | 148 | 152 | 65 | 65 | 65 |
| L* value of substrate | | — | — | 60 | 60 | 60 |
| L* value of ink receiving layer | | 50 | 50 | — | — | — |
| L* value of decorative layer | C:M:Y | 56 | 55 | 58 | 57 | 56 |
| | C:M | 56 | 55 | 57 | 57 | 56 |
| | M:Y | 56 | 55 | 57 | 55 | 54 |
| | Y:C | 55 | 55 | 58 | 56 | 58 |
| Evaluation 2 of color | C:M:Y | 6 | 5 | 27 | 25 | 26 |
| reproducibility of mixed color | C:M | 6 | 5 | 28 | 28 | 27 |
| Difference in hue angle [symbol] H° | M:Y | 5 | 5 | 29 | 26 | 25 |
| of mixed color printed | Y:C | 7 | 7 | 26 | 24 | 26 |
| material = w | | | | | | |
| Evaluation 3 of color | C:M:Y | 6 | 5 | 26 | 24 | 23 |
| reproducibility of mixed color | C:M | 6 | 5 | 31 | 31 | 27 |
| Color difference between a | M:Y | 5 | 5 | 27 | 24 | 22 |
| value and b value of mixed | Y:C | 6 | 6 | 28 | 25 | 28 |
| color printed material = ΔC_{ab} | | | | | | |
| Contrast ratio (%) | Ch | 56 | 56 | 5 | 5 | 5 |
| | Yh | 57 | 57 | 7 | 26 | 7 |
| | Mh | 59 | 57 | 8 | 8 | 30 |
| Difference in contrast ratio | \|Ch − Mh\| | 3 | 1 | 3 | 3 | 25 |
| | \|Mh − Yh\| | 2 | 0 | 1 | 18 | 23 |
| | \|Yh − Ch\| | 1 | 1 | 2 | 21 | 2 |
| Evaluation results | Gradation of | ⊙ | ⊙ | X | X | X |
| | mixed color | | | | | |
| | Color density | ⊙ | ⊙ | X | X | X |
| | of mixed color | | | | | |
| | Visibility | ⊙ | ⊙ | X | X | X |
| | and color | | | | | |
| | developability | | | | | |

TABLE 19

| | | Comparative | Comparative | Comparative | Comparative |
|---|---|---|---|---|---|
| | | Example 4 | Example 5 | Example 6 | Example 7 |
| Ink set | | C2 | C5 | C2 | C5 |
| | | Y1 | Y2 | Y5 | Y5 |
| Substrate | | M1 | M4 | M5 | M2 |
| | | Rigid | Rigid | Rigid | Rigid |
| | | polyvinyl | polyvinyl | polyvinyl | polyvinyl |
| | | chloride^{a)} | chloride^{a)} | chloride^{a)} | chloride^{a)} |
| Ink receiving layer | | — | — | — | — |
| Setting time (sec) | | 3 | 3 | 3 | 3 |
| Average dot diameter | | 65 | 65 | 68 | 65 |
| L* value of substrate | | 60 | 60 | 60 | 60 |
| L* value of ink receiving layer | | — | — | — | — |
| L* value of decorative | C:M:Y | 58 | 53 | 56 | 56 |
| layer | C:M | 58 | 50 | 53 | 56 |
| | M:Y | 57 | 56 | 52 | 57 |
| | Y:C | 57 | 55 | 53 | 51 |
| Evaluation 2 of color | C:M:Y | 25 | 25 | 26 | 27 |
| reproducibility of | C:M | 25 | 9 | 25 | 26 |
| mixed color | M:Y | 29 | 27 | 9 | 25 |
| Difference in hue | Y:C | 24 | 26 | 19 | 9 |
| angle ∠H° of mixed | | | | | |
| color printed | | | | | |
| material = w | | | | | |
| Evaluation 3 of color | C:M:Y | 24 | 26 | 28 | 29 |
| reproducibility of | C:M | 29 | 11 | 35 | 31 |
| mixed color | M:Y | 27 | 18 | 13 | 29 |
| Color difference | Y:C | 26 | 33 | 21 | 14 |
| between a value and b | | | | | |
| value of mixed color | | | | | |
| printed material = ΔC_{ab} | | | | | |
| Contrast ratio (%) | Ch | 17 | 53 | 17 | 53 |
| | Yh | 7 | 26 | 56 | 56 |
| | Mh | 8 | 49 | 62 | 30 |
| Difference in contrast | \|Ch − Mh\| | 9 | 4 | 45 | 23 |
| ratio | \|Mh − Yh\| | 1 | 23 | 6 | 26 |
| | \|Yh − Ch\| | 10 | 27 | 39 | 3 |
| Evaluation results | Gradation of mixed | x | x | x | x |
| | color | | | | |
| | Color density of | x | x | x | x |
| | mixed color | | | | |
| | Visibility and color | x | Δ | Δ | Δ |
| | developability | | | | |

What is claimed is:

1. A coated body comprising a substrate and a decorative layer,
wherein the decorative layer is formed from an ink set comprising at least a cyan ink, a magenta ink, and a yellow ink, and
all of Ch, Mh, and Yh are 10% or more, in which Ch, Mh, and Yh are contrast ratios (%) of dried films having a thickness of 10 μm formed from the cyan ink, the magenta ink, and the yellow ink, respectively, and all of the following Relational Expressions (1) to (3) are satisfied:
0≤|Ch−Mh|≤25%; Expression (1)
0≤|Mh−Yh|≤25%; and Expression (2)
0≤|Yh−Ch|≤25%. Expression (3)

2. The coated body according to claim 1, wherein a surface on which the decorative layer is printed has an L* value of 40.0 to 98.0 in a CIE(1976)L*a*b* color space.

3. The coated body according to claim 1, wherein the cyan ink contains a white pigment.

4. The coated body according to claim 1, wherein the yellow ink contains a white pigment.

5. The coated body according to claim 1, wherein a hue angle ∠H° of a dried film having a thickness of 10 μm formed from the cyan ink is in a range of 230° to 270°, a hue angle ∠H° of a dried film having a thickness of 10 μm formed from the magenta ink is in a range of 26° to 42°, a hue angle ∠H° of a dried film having a thickness of 10 μm formed from a yellow ink is in a range of 75° to 110°, wherein the hue angle ∠H° of a dried film having a thickness of 10 μm formed from the cyan ink, the hue angle ∠H° of a dried film having a thickness of 10 μm formed from the magenta ink, and the hue angle ∠H° of a dried film having a thickness of 10 μm formed from the yellow ink are values measured on a white substrate.

6. The coated body according to claim 1, wherein a hue angle ∠H° of a dried film having a thickness of 10 μm formed by color mixing of the cyan ink and the magenta ink at a volume ratio of 1:1 is in a range of −20° to 25°, a hue angle ∠H° of a dried film having a thickness of 10 μm formed by color mixing of the magenta ink and the yellow ink at a volume ratio of 1:1 is in a range of 43° to 74°, a hue angle ∠H° of a dried film having a thickness of 10 μm formed by color mixing of the yellow ink and the cyan ink at a volume ratio of 1:1 is in a range of 111° to 160°, wherein the hue angle ∠H° of a dried film having a thickness of 10 μm formed by color mixing of the cyan ink and the magenta ink at a volume ratio of 1:1, the hue angle ∠H° of a dried film having a thickness of 10 μm formed by color mixing of the magenta ink and the yellow ink at a volume ratio of 1:1, and the hue angle ∠H° of a dried film having a thickness of 10 μm formed by color mixing of the yellow ink and the cyan ink at a volume ratio of 1:1 are values measured on a white substrate.

7. The coated body according to claim 1, wherein all of Ch, Mh, and Yh are within a range of 55±25%.

8. The coated body according to claim 1, wherein at least one of the inks constituting the ink set is an active energy ray curable ink containing a polymerizable compound containing an alkylene oxide as a structural unit.

9. The coated body according to claim 1, wherein the magenta ink contains an iron oxide pigment, and a content of magnetite in the iron oxide pigment is 5 mass % or less.

10. The coated body according to claim 9, wherein the iron oxide pigment is Pigment Red 101.

11. The coated body according to claim 1, wherein the decorative layer is formed from a plurality of dot-shaped inks, and an average dot diameter of the inks is within a range of 70 μm to 250 μm.

12. The coated body according to claim 1, further comprising an ink receiving layer,
wherein a surface on which the decorative layer is printed is a surface of the ink receiving layer.

13. The coated body according to claim 12, wherein the ink receiving layer contains a crosslinked resin.
